(19) United States
(12) Patent Application Publication
(10) Pub. No.: US 2024/0394931 A1
(43) Pub. Date: Nov. 28, 2024

(54) CLOUD-BASED VIRTUAL VIEW FOR VEHICLE-TO-VEHICLE (V2V) APPLICATIONS

(71) Applicant: QUALCOMM Incorporated, San Diego, CA (US)

(72) Inventors: Anantharaman BALASUBRAMANIAN, San Diego, CA (US); Kapil GULATI, Belle Mead, NJ (US); Dan VASSILOVSKI, Del Mar, CA (US); Jubin JOSE, Basking Ridge, NJ (US)

(21) Appl. No.: 18/323,252

(22) Filed: May 24, 2023

(51) Int. Cl. G06T 11/00; B60R 1/28; G06T 3/40; G06T 7/33; G06V 10/75

(52) U.S. Cl. CPC G06T 11/00; B60R 1/28; G06T 3/4038; G06T 7/33; G06V 10/751; G06V 10/759; B60R 2300/802; G06T 2207/20104; G06T 2207/20221; G06T 2207/30248; H04W 4/46

(57) ABSTRACT

Disclosed are systems and techniques for wireless communications. For example, a device can receive, from a first vehicle, a view request for a visual view of a region of interest (ROI). The device can transmit a request for key points and feature descriptors related to a view of the first vehicle and respective view(s) of the other vehicle(s), and can match the key points/feature descriptors related to the other vehicle(s) and the first vehicle. The device can determine, based on the matching, at least one vehicle to provide at least one ROI view of the ROI and determine at least one mapping between the at least one vehicle and the first vehicle, which can be used to combine the at least one ROI view of the at least one vehicle with the view of the first vehicle to generate a combined image having the visual view of the ROI.

### FIELD

The present disclosure generally relates to vehicle communications. For example, aspects of the present disclosure relate to a cloud-based virtual view for vehicle-to-vehicle (V2V) applications.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (cMBB), massive machine type communications (mMTC), and ultra-reliable low latency communications (URLLC). Some aspects of 5G NR may be based on the 4G Long Term Evolution (LTE) standard. Aspects of wireless communication may comprise direct communication between devices, such as in vehicle-to-everything (V2X), vehicle-to-vehicle (V2V), and/or device-to-device (D2D) communication. There exists a need for further improvements in V2X, V2V, and/or D2D technology. These improvements may also be applicable to other multi-access technologies and the telecommunication standards that employ these technologies.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, apparatuses, methods and computer-readable media for a cloud-based virtual view for V2V applications. According to at least one illustrative example, an apparatus for wireless communications is provided. The apparatus includes at least one memory and at least one processor coupled to the at least one memory and configured to: receive, from a first vehicle, a view request for a visual view of a region of interest (ROI); output, for transmission to the first vehicle and one or more other vehicles, an information request for key points and associated feature descriptors related to a view of the first vehicle and key points and associated feature descriptors related to one or more respective views of the one or more other vehicles; match the key points and the associated feature descriptors related to the one or more other vehicles to the key points and the associated feature descriptors related to the first vehicle; determine, based on the matching, at least one vehicle of the one or more other vehicles to provide at least one ROI view of the ROI; determine at least one mapping between the at least one vehicle and the first vehicle; and combine, using the at least one mapping, the at least one ROI view of the at least one vehicle with the view of the first vehicle to generate a combined image having the visual view of the ROI.

In another illustrative example, a method is provided for wireless communications by a device. The method includes: receiving, by the device from a first vehicle, a view request for a visual view of a region of interest (ROI); transmitting, by the device to the first vehicle and one or more other vehicles, an information request for key points and associated feature descriptors related to a view of the first vehicle and key points and associated feature descriptors related to one or more respective views of the one or more other vehicles; matching, by the device, the key points and the associated feature descriptors related to the one or more other vehicles to the key points and the associated feature descriptors related to the first vehicle; determining, by the device based on the matching, at least one vehicle of the one or more other vehicles to provide at least one ROI view of the ROI; determining, by the device, at least one mapping between the at least one vehicle and the first vehicle; and combining, by the device using the at least one mapping, the at least one ROI view of the at least one vehicle with the view of the first vehicle to generate a combined image having the visual view of the ROI.

In another illustrative example, a non-transitory computer-readable storage medium is provided comprising instructions stored thereon which, when executed by at least one processor, causes the at least one processor to: receive, from a first vehicle, a view request for a visual view of a region of interest (ROI); output, for transmission to the first vehicle and one or more other vehicles, an information request for key points and associated feature descriptors related to a view of the first vehicle and key points and associated feature descriptors related to one or more respective views of the one or more other vehicles; match the key points and the associated feature descriptors related to the one or more other vehicles to the key points and the associated feature descriptors related to the first vehicle; determine, based on the matching, at least one vehicle of the one or more other vehicles to provide at least one ROI view of the ROI; determine at least one mapping between the at least one vehicle and the first vehicle; and combine, using the at least one mapping, the at least one ROI view of the at least one vehicle with the view of the first vehicle to generate a combined image having the visual view of the ROI.

In another illustrative example, an apparatus for wireless communications is provided. The apparatus includes: means for receiving, from a first vehicle, a view request for a visual view of a region of interest (ROI); means for transmitting, to the first vehicle and one or more other vehicles, an information request for key points and associated feature descriptors related to a view of the first vehicle and key points and associated feature descriptors related to one or more respective views of the one or more other vehicles; means for matching the key points and the associated feature descriptors related to the one or more other vehicles to the key points and the associated feature descriptors related to the first vehicle; means for determining, based on the matching, at least one vehicle of the one or more other vehicles to provide at least one ROI view of the ROI; means for determining at least one mapping between the at least one vehicle and the first vehicle; and means for combining, using the at least one mapping, the at least one ROI view of the at least one vehicle with the view of the first vehicle to generate a combined image having the visual view of the ROI.

Aspects generally include a method, apparatus, system, computer program product, non-transitory computer-readable medium, user device, user equipment, wireless communication device, and/or processing system as substantially described with reference to and as illustrated by the drawings and specification.

In some aspects, one or more of the apparatuses described herein is, is part of, or includes a vehicle (e.g., an automobile, truck, etc., or a component or system of an automobile, truck, etc.), a mobile device (e.g., a mobile telephone or so-called “smart phone” or other mobile device), a wearable device, an extended reality device (e.g., a virtual reality (VR) device, an augmented reality (AR) device, or a mixed reality (MR) device), a personal computer, a laptop computer, a server computer, a robotics device, or other device. In some aspects, the apparatus includes radio detection and ranging (radar) for capturing radio frequency (RF) signals. In some aspects, the apparatus includes one or more light detection and ranging (LIDAR) sensors, radar sensors, or other light-based sensors for capturing light-based (e.g., optical frequency) signals. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors, which can be used for determining a location of the apparatuses, a state of the apparatuses (e.g., a temperature, a humidity level, and/or other state), and/or for other purposes.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended for use in isolation to determine the scope of the claimed subject matter. The subject matter should be understood by reference to appropriate portions of the entire specification of this patent, any or all drawings, and each claim.

Other objects and advantages associated with the aspects disclosed herein will be apparent to those skilled in the art based on the accompanying drawings and detailed description.

### BRIEF DESCRIPTION OF THE DRAWINGS

Illustrative aspects of the present application are described in detail below with reference to the following figures:

FIG. 1 is a diagram illustrating an example wireless communications system, in accordance with some aspects of the present disclosure.

FIG. 2 is a diagram illustrating an example of a disaggregated base station architecture, which may be employed by the disclosed system for a cloud-based virtual view for V2V applications, in accordance with some aspects of the present disclosure.

FIG. 3 is a diagram illustrating an example of various user equipment (UEs) communicating over direct communication interfaces (e.g., a cellular based PC5 sidelink interface, 802.11p defined dedicated short-range communications (DSRC) interface, or other direct interface) and wide area network (Uu) interfaces, in accordance with some aspects of the present disclosure.

FIG. 4 is a block diagram illustrating an example of a computing system of a vehicle, in accordance with some aspects of the present disclosure.

FIG. 5 is a diagram illustrating an example of a system for sensor sharing in wireless communications (e.g., V2X communications), in accordance with some aspects of the present disclosure.

FIG. 6 is a diagram illustrating an example of a vehicle-based message (shown as a sensor-sharing message), in accordance with some aspects of the present disclosure.

FIG. 7 is a diagram illustrating an example of a raw sensor sharing for a blind spot area, in accordance with some aspects of the present disclosure.

FIG. 8 is a diagram illustrating an example of signaling for raw sensor sharing, in accordance with some aspects of the present disclosure.

FIG. 9 is a diagram illustrating an example scenario where a vehicle's view of the road is blocked by a truck, in accordance with some aspects of the present disclosure.

FIG. 10 is a diagram illustrating an example scenario where a vehicle desires to overtake another vehicle, but has a blocked view of the road, in accordance with some aspects of the present disclosure.

FIG. 11 is a diagram illustrating an example scenario where a vehicle has a blocked view of an upcoming intersection in the road, in accordance with some aspects of the present disclosure.

FIG. 12 is a diagram illustrating an example scenario where a vehicle is requesting a view of a region of interest (ROI), in accordance with some aspects of the present disclosure.

FIG. 13 is a diagram illustrating an example of generating a combined (e.g., stitched) image that includes a view of an ROI for a vehicle, in accordance with some aspects of the present disclosure.

FIG. 14 is a flow chart illustrating an example of a process for a cloud-based virtual view for V2V applications, according to some aspects of the present disclosure.

FIG. 15 illustrates an example computing system, according to aspects of the disclosure.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Wireless communications systems are deployed to provide various telecommunication services, including telephony, video, data, messaging, broadcasts, among others. Wireless communications systems have developed through various generations. A fifth generation (5G) mobile standard calls for higher data transfer speeds, greater numbers of connections, and better coverage, among other improvements. The 5G standard (also referred to as “New Radio” or “NR”), according to the Next Generation Mobile Networks Alliance, is designed to provide data rates of several tens of megabits per second to each of tens of thousands of users.

Vehicles are an example of systems that can include wireless communications capabilities. For example, vehicles (e.g., automotive vehicles, autonomous vehicles, aircraft, maritime vessels, among others) can communicate with other vehicles and/or with other devices that have wireless communications capabilities. Wireless vehicle communication systems encompass vehicle-to-vehicle (V2V), vehicle-to-infrastructure (V2I), vehicle-to-network (V2N), and vehicle-to-pedestrian (V2P) communications, vehicle-to-grid (V2G) communications (e.g., data going to the electric grid, such as for the purpose of actively managing energy in electric vehicles or other electric devices or systems), which are all collectively referred to as vehicle-to-everything (V2X) communications. V2X communications is a vehicular communication system that supports the wireless transfer of information from a vehicle to other entities (e.g., other vehicles, pedestrians with smart phones, equipped vulnerable road users (VRUs), such as bicyclists, and/or other traffic infrastructure) located within the traffic system that may affect the vehicle. The main purpose of the V2X technology is to improve road safety, fuel savings, and traffic efficiency.

In a V2X communication system, information is transmitted from vehicle sensors (and other sources) through wireless links to allow the information to be communicated to other vehicles, pedestrians, VRUs, and/or traffic infrastructure. The information may be transmitted using one or more vehicle-based messages, such as cellular-vehicle-to-everything (C-V2X) messages, which can include Sensor Data Sharing Messages (SDSMs), Basic Safety Messages (BSMs), Cooperative Awareness Messages (CAMs), Collective Perception Messages (CPMs), Decentralized Environmental Messages (DENMs), and/or other types of vehicle-based messages. By sharing this information with other vehicles, the V2X technology improves vehicle (and driver) awareness of potential dangers to help reduce collisions with other vehicles and entities. In addition, the V2X technology enhances traffic efficiency by providing traffic warnings to vehicles of potential upcoming road dangers and obstacles such that vehicles may choose alternative traffic routes.

As previously mentioned, the V2X technology includes V2V communications, which can also be referred to as peer-to-peer communications. V2V communications allows for vehicles to directly wireless communicate with each other while on the road. With V2V communications, vehicles can gain situational awareness by receiving information regarding upcoming road dangers (e.g., unforeseen oncoming vehicles, accidents, and road conditions) from the other vehicles.

The IEEE 802.11p Standard supports (uses) a dedicated short-range communications (DSRC) interface for V2X wireless communications. Characteristics of the IEEE 802.11p based DSRC interface include low latency and the use of the unlicensed 5.9 Gigahertz (GHz) frequency band. C-V2X was adopted as an alternative to using the IEEE 802.11p based DSRC interface for the wireless communications. The 5G Automotive Association (5GAA) supports the use of C-V2X technology. In some cases, the C-V2X technology uses Long-Term Evolution (LTE) as the underlying technology, and the C-V2X functionalities are based on the LTE technology. C-V2X includes a plurality of operational modes. One of the operational modes allows for direct wireless communication between vehicles over the LTE sidelink PC5 interface. Similar to the IEEE 802.11p based DSRC interface, the LTE C-V2X sidelink PC5 interface operates over the 5.9 GHz frequency band. Vehicle-based messages, such as BSMs and CAMs, which are application layer messages, are designed to be wirelessly broadcasted over the 802.11p based DSRC interface and the LTE C-V2X sidelink PC5 interface.

As previously mentioned, vehicles share sensor information with each other to obtain situational awareness of their environment. Sensor sharing has been addressed in the Society of Automobile Engineers (SAE) standards. For example, SAE J3224 addresses V2X sensor sharing for cooperative and automated driving. In particular, SAE J3224 defines the V2X message structure and information elements for roadside units (RSUs) and vehicles to exchange information with each other regarding detected objects and road users.

One of the aspects of SAE J3224 is raw sensor sharing, which involves a high resolution video streaming exchange performed between vehicles in real time to detect blind spots. In some scenarios, a roadside unit (RSU) and/or other vehicles may be able to provide blind spot specific sensor information that a remote vehicle is unable to sense. However, since raw sensor sharing involves streaming large amounts of high resolution video, raw sensor sharing requires a very high bandwidth. A remote vehicle will need to support this very high bandwidth requirement in order to be able to receive the raw sensor data from all of the surrounding vehicles.

In one or more aspects of the present disclosure, systems, apparatuses, methods (also referred to as processes), and computer-readable media (collectively referred to herein as “systems and techniques”) are described herein that provide a cloud-based virtual view for V2V applications. The systems and techniques can allow for a server (e.g., a car-to-cloud server) to provide a visual view (referred to as a panoramic visual view), which includes blind spot specific information within a region of interest, to a vehicle with a blocked view. The systems and techniques provide procedures and associated signaling required for a server (e.g., a car-to-cloud server) to be able to stitch visual information obtained from vehicles and to present a panoramic visual view from the point of view of a blocked vehicle. The signaling aspects disclosed emphasize stitching aspects for sensor fusion.

In one or more aspects, a process for generating a panoramic visual view involves the first vehicle requesting from a server (e.g., a car-to-cloud server) a panoramic visual view on a specific region of interest (ROI), such as a blind spot area for the first vehicle. The server can then request the first vehicle as well as other vehicles (e.g., a second vehicle, a third vehicle, and a fourth vehicle), which are located in the vicinity of the first vehicle, to provide visual key points and associated feature descriptors of their respective views. The server can match the key points and descriptors received from the other vehicles (e.g., a second vehicle, a third vehicle, and a fourth vehicle) with the key points and descriptors received from the first vehicle.

The server can then determine appropriate vehicles (e.g., only the second vehicle and third vehicle, not the fourth vehicle) that can provide a panoramic view of the ROI requested by the first vehicle. The server can determine or infer a mapping (e.g., a homography) between the first vehicle and each of the appropriate vehicles (e.g., the homography between the first vehicle and second vehicle, and the homography between the first vehicle and third vehicle). The server can use the inferred mappings (e.g., homographies) to combine (e.g., stitch together) an image including a panoramic visual view that includes the ROI. The server can then provide the generated combined (e.g., stitched) image to the first vehicle.

Additional aspects of the present disclosure are described in more detail below.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.) and so on.

In some cases, a network entity can be implemented in an aggregated or monolithic base station or server architecture, or alternatively, in a disaggregated base station or server architecture, and may include one or more of a central unit (CU), a distributed unit (DU), a radio unit (RU), a Near-Real Time (Near-RT) RAN Intelligent Controller (RIC), or a Non-Real Time (Non-RT) RIC. In some cases, a network entity can include a server device, such as a Multi-access Edge Compute (MEC) device. A base station or server (e.g., with an aggregated/monolithic base station architecture or disaggregated base station architecture) may operate according to one of several RATs in communication with UEs, roadside units (RSUs), and/or other devices depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, or a forward traffic channel, etc.). The term traffic channel (TCH), as used herein, can refer to either an uplink, reverse or downlink, and/or a forward traffic channel.

The term “network entity” or “base station” (e.g., with an aggregated/monolithic base station architecture or disaggregated base station architecture) may refer to a single physical TRP or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals (or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

A roadside unit (RSU) is a device that can transmit and receive messages over a communications link or interface (e.g., a cellular-based sidelink or PC5 interface, an 802.11 or WiFi™ based Dedicated Short Range Communication (DSRC) interface, and/or other interface) to and from one or more UEs, other RSUs, and/or base stations. An example of messages that can be transmitted and received by an RSU includes vehicle-to-everything (V2X) messages, which are described in more detail below. RSUs can be located on various transportation infrastructure systems, including roads, bridges, parking lots, toll booths, and/or other infrastructure systems. In some examples, an RSU can facilitate communication between UEs (e.g., vehicles, pedestrian user devices, and/or other UEs) and the transportation infrastructure systems. In some implementations, a RSU can be in communication with a server, base station, and/or other system that can perform centralized management functions.

An RSU can communicate with a communications system of a UE. For example, an intelligent transport system (ITS) of a UE (e.g., a vehicle and/or other UE) can be used to generate and sign messages for transmission to an RSU and to validate messages received from an RSU. An RSU can communicate (e.g., over a PC5 interface, DSRC interface, etc.) with vehicles traveling along a road, bridge, or other infrastructure system in order to obtain traffic-related data (e.g., time, speed, location, etc. of the vehicle). In some cases, in response to obtaining the traffic-related data, the RSU can determine or estimate traffic congestion information (e.g., a start of traffic congestion, an end of traffic congestion, etc.), a travel time, and/or other information for a particular location. In some examples, the RSU can communicate with other RSUs (e.g., over a PC5 interface, DSRC interface, etc.) in order to determine the traffic-related data. The RSU can transmit the information (e.g., traffic congestion information, travel time information, and/or other information) to other vehicles, pedestrian UEs, and/or other UEs. For example, the RSU can broadcast or otherwise transmit the information to any UE (e.g., vehicle, pedestrian UE, etc.) that is in a coverage range of the RSU.

A radio frequency signal or “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

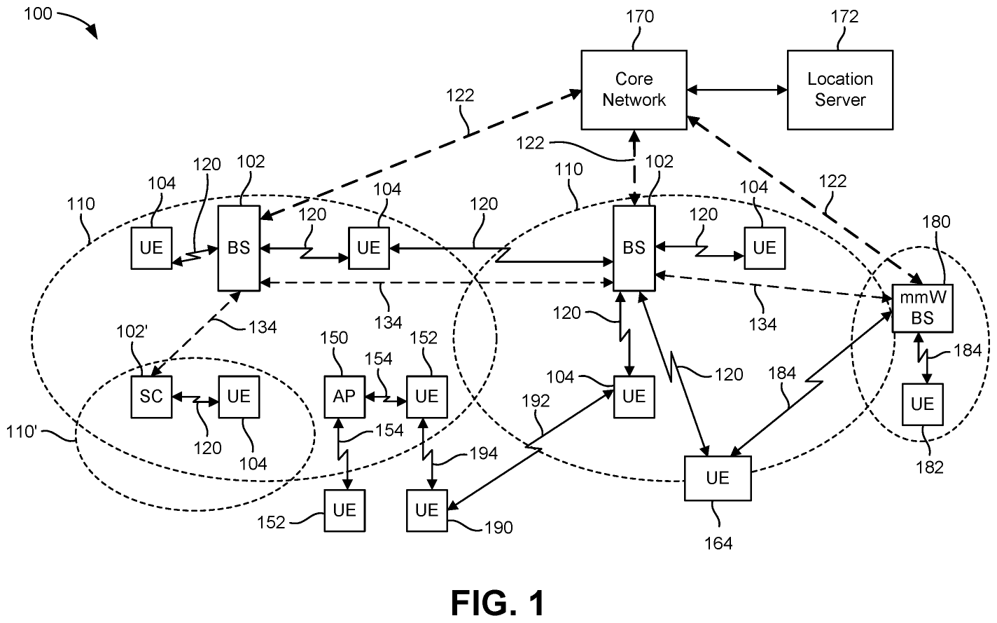

According to various aspects, FIG. 1 illustrates an exemplary wireless communications system 100. The wireless communications system 100 (which may also be referred to as a wireless wide area network (WWAN)) can include various base stations 102 and various UEs 104. In some aspects, the base stations 102 may also be referred to as “network entities” or “network nodes.” One or more of the base stations 102 can be implemented in an aggregated or monolithic base station architecture. Additionally or alternatively, one or more of the base stations 102 can be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 can include macro cell base stations (high power cellular base stations) and/or small cell base stations (low power cellular base stations). In an aspect, the macro cell base station may include eNBs and/or ng-eNBs where the wireless communications system 100 corresponds to a long term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (cMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 can include devices (e.g., UEs, etc.) that communicate with one or more UEs 104, base stations 102, APs 150, etc. utilizing the ultra-wideband (UWB) spectrum. The UWB spectrum can range from 3.1 to 10.5 GHZ.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHZ with a wavelength of 100 millimeters. The super high frequency (SHF) band extends between 3 GHZ and 30 GHZ, also referred to as centimeter wave. Communications using the mmW and/or near mmW radio frequency band have high path loss and a relatively short range. The mmW base station 180 and the UE 182 may utilize beamforming (transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node or entity (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while canceling to suppress radiation in undesired directions.

Transmit beams may be quasi-collocated, meaning that they appear to the receiver (e.g., a UE) as having the same parameters, regardless of whether or not the transmitting antennas of the network node themselves are physically collocated. In NR, there are four types of quasi-collocation (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receiving beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain of other beams available to the receiver. This results in a stronger received signal strength, (e.g., reference signal received power (RSRP), reference signal received quality (RSRQ), signal-to-interference-plus-noise ratio (SINR), etc.) of the RF signals received from that direction.

Receive beams may be spatially related. A spatial relation means that parameters for a transmit beam for a second reference signal can be derived from information about a receive beam for a first reference signal. For example, a UE may use a particular receive beam to receive one or more reference downlink reference signals (e.g., positioning reference signals (PRS), tracking reference signals (TRS), phase tracking reference signal (PTRS), cell-specific reference signals (CRS), channel state information reference signals (CSI-RS), primary synchronization signals (PSS), secondary synchronization signals (SSS), synchronization signal blocks (SSBs), etc.) from a network node or entity (e.g., a base station). The UE can then form a transmit beam for sending one or more uplink reference signals (e.g., uplink positioning reference signals (UL-PRS), sounding reference signal (SRS), demodulation reference signals (DMRS), PTRS, etc.) to that network node or entity (e.g., a base station) based on the parameters of the receive beam.

Note that a “downlink” beam may be either a transmit beam or a receive beam, depending on the entity forming it. For example, if a network node or entity (e.g., a base station) is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a network node or entity (e.g., a base station) is forming the uplink beam, it is an uplink receive beam, and if a UE is forming the uplink beam, it is an uplink transmit beam.

In 5G, the frequency spectrum in which wireless network nodes or entities (e.g., base stations 102/180, UEs 104/182) operate is divided into multiple frequency ranges, FR1 (from 450 to 6000 Megahertz (MHZ)), FR2 (from 24250 to 52600 MHZ), FR3 (above 52600 MHz), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency and/or component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHZ (e.g., 5, 10, 15, 20, 100 MHZ) bandwidth per carrier up to a total of Yx MHZ (x component carriers) for transmission in each direction. The component carriers may or May not be adjacent to each other on the frequency spectrum. Allocation of carriers may be asymmetric with respect to the downlink and uplink (e.g., more or less carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In order to operate on multiple carrier frequencies, a base station 102 and/or a UE 104 is equipped with multiple receivers and/or transmitters. For example, a UE 104 may have two receivers, “Receiver 1” and “Receiver 2,” where “Receiver 1” is a multi-band receiver that can be tuned to band (i.e., carrier frequency) ‘X’ or band ‘Y,’ and “Receiver 2” is a one-band receiver tuneable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (an SCell) in order to measure band ‘Y’ (and vice versa). In contrast, whether the UE 104 is being served in band ‘X’ or band ‘Y,’ because of the separate “Receiver 2,” the UE 104 can measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

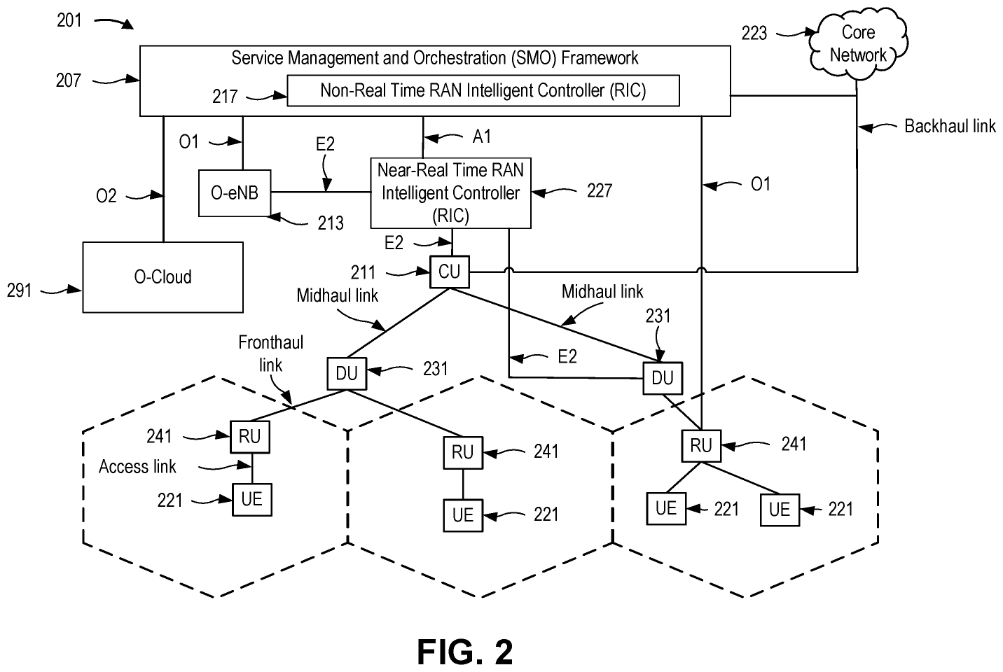

FIG. 2 is a diagram illustrating an example of a disaggregated base station architecture, which may be employed by the disclosed system for a cloud-based virtual view for V2V applications. Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, AP, a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

As previously mentioned, FIG. 2 shows a diagram illustrating an example disaggregated base station 201 architecture. The disaggregated base station 201 architecture may include one or more central units (CUs) 211 that can communicate directly with a core network 223 via a backhaul link, or indirectly with the core network 223 through one or more disaggregated base station units (such as a Near-Real Time (Near-RT) RAN Intelligent Controller (RIC) 227 via an E2 link, or a Non-Real Time (Non-RT) RIC 217 associated with a Service Management and Orchestration (SMO) Framework 207, or both). A CU 211 may communicate with one or more distributed units (DUs) 231 via respective midhaul links, such as an F1 interface. The DUs 231 may communicate with one or more radio units (RUS) 241 via respective fronthaul links. The RUs 241 may communicate with respective UEs 221 via one or more RF access links. In some implementations, the UE 221 may be simultaneously served by multiple RUs 241.

Each of the units, i.e., the CUS 211, the DUs 231, the RUs 241, as well as the Near-RT RICs 227, the Non-RT RICs 217 and the SMO Framework 207, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 211 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 211. The CU 211 may be configured to handle user plane functionality (i.e., Central Unit-User Plane (CU-UP)), control plane functionality (i.e., Central Unit-Control Plane (CU-CP)), or a combination thereof. In some implementations, the CU 211 can be logically split into one or more CU-UP units and one or more CU-CP units. The CU-UP unit can communicate bidirectionally with the CU-CP unit via an interface, such as the E1 interface when implemented in an O-RAN configuration. The CU 211 can be implemented to communicate with the DU 131, as necessary, for network control and signaling.

The DU 231 may correspond to a logical unit that includes one or more base station functions to control the operation of one or more RUs 241. In some aspects, the DU 231 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 231 may further host one or more low PHY layers. Each layer (or module) can be implemented with an interface configured to communicate signals with other layers (and modules) hosted by the DU 231, or with the control functions hosted by the CU 211.

Lower-layer functionality can be implemented by one or more RUs 241. In some deployments, an RU 241, controlled by a DU 231, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 241 can be implemented to handle over the air (OTA) communication with one or more UEs 221. In some implementations, real-time and non-real-time aspects of control and user plane communication with the RU(s) 241 can be controlled by the corresponding DU 231. In some scenarios, this configuration can enable the DU(s) 231 and the CU 211 to be implemented in a cloud-based RAN architecture, such as a vRAN architecture.

The SMO Framework 207 may be configured to support RAN deployment and provisioning of non-virtualized and virtualized network elements. For non-virtualized network elements, the SMO Framework 207 may be configured to support the deployment of dedicated physical resources for RAN coverage requirements which may be managed via an operations and maintenance interface (such as an O1 interface). For virtualized network elements, the SMO Framework 207 may be configured to interact with a cloud computing platform (such as an open cloud (O-Cloud) 291) to perform network element life cycle management (such as to instantiate virtualized network elements) via a cloud computing platform interface (such as an O2 interface). Such virtualized network elements can include, but are not limited to, CUs 211, DUs 231, RUs 241 and Near-RT RICs 227. In some implementations, the SMO Framework 207 can communicate with a hardware aspect of a 4G RAN, such as an open eNB (O-cNB) 213, via an O1 interface. Additionally, in some implementations, the SMO Framework 207 can communicate directly with one or more RUs 241 via an O1 interface. The SMO Framework 207 also may include a Non-RT RIC 217 configured to support functionality of the SMO Framework 207.

The Non-RT RIC 217 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 227. The Non-RT RIC 217 may be coupled to or communicate with (such as via an A1 interface) the Near-RT RIC 227. The Near-RT RIC 227 may be configured to include a logical function that enables near-real-time control and optimization of RAN elements and resources via data collection and actions over an interface (such as via an E2 interface) connecting one or more CUs 211, one or more DUs 231, or both, as well as an O-eNB 213, with the Near-RT RIC 227.

In some implementations, to generate AI/ML models to be deployed in the Near-RT RIC 227, the Non-RT RIC 217 may receive parameters or external enrichment information from external servers. Such information may be utilized by the Near-RT RIC 227 and may be received at the SMO Framework 207 or the Non-RT RIC 217 from non-network data sources or from network functions. In some examples, the Non-RT RIC 217 or the Near-RT RIC 227 may be configured to tune RAN behavior or performance. For example, the Non-RT RIC 217 may monitor long-term trends and patterns for performance and employ AI/ML models to perform corrective actions through the SMO Framework 207 (such as reconfiguration via 01) or via creation of RAN management policies (such as A1 policies).

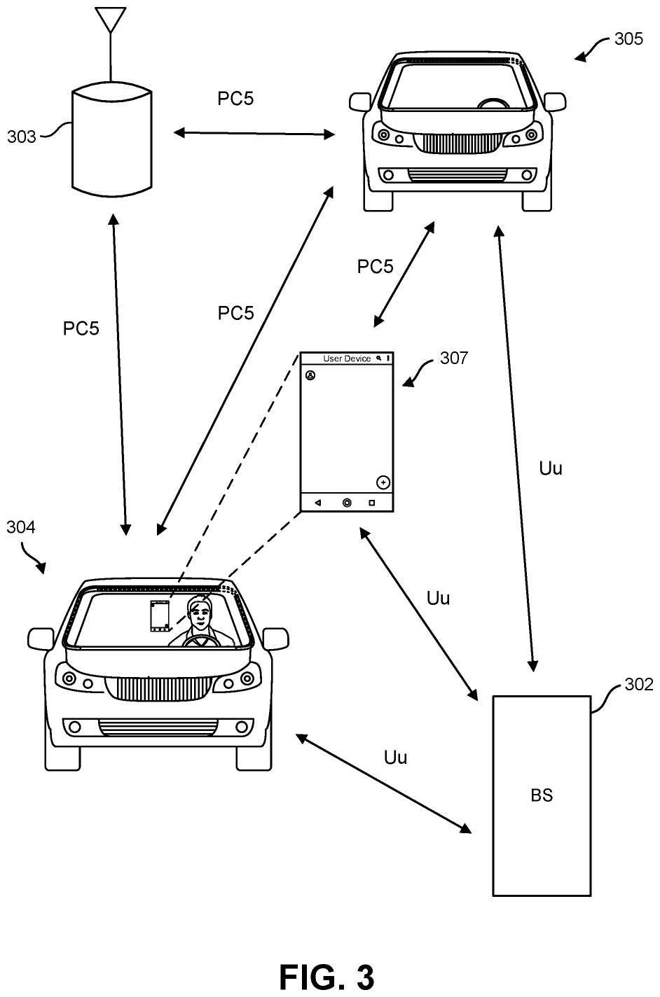

FIG. 3 illustrates examples of different communication mechanisms used by various UEs. In one example of sidelink communications, FIG. 3 illustrates a vehicle 304, a vehicle 305, and an RSU 303 communicating with each other using PC5, DSRC, or other device to device direct signaling interfaces. In addition, the vehicle 304 and the vehicle 305 may communicate with a base station 302 (shown as BS 302) using a network (Uu) interface. The base station 302 can include a gNB in some examples. FIG. 3 also illustrates a user device 307 communicating with the base station 302 using a network (Uu) interface. As described below, functionalities can be transferred from a vehicle (e.g., vehicle 304) to a user device (e.g., user device 307) based on one or more characteristics or factors (e.g., temperature, humidity, etc.). In one illustrative example, V2X functionality can be transitioned from the vehicle 304 to the user device 307, after which the user device 307 can communicate with other vehicles (e.g., vehicle 305) over a PC5 interface (or other device to device direct interface, such as a DSRC interface), as shown in FIG. 3.

While FIG. 3 illustrates a particular number of vehicles (e.g., two vehicles 304 and 305) communicating with each other and/or with RSU 303, BS 302, and/or user device 307, the present disclosure is not limited thereto. For instance, tens or hundreds of such vehicles may be communicating with one another and/or with RSU 303, BS 302, and/or user device 307. At any given point in time, each such vehicle, RSU 303, BS 302, and/or user device 307 may transmit various types of information as messages to other nearby vehicles resulting in each vehicle (e.g., vehicles 304 and/or 305), RSU 303, BS 302, and/or user device 307 receiving hundreds or thousands of messages from other nearby vehicles, RSUs, base stations, and/or other UEs per second.

While PC5 interfaces are shown in FIG. 3, the various UEs (e.g., vehicles, user devices, etc.) and RSU(s) can communicate directly using any suitable type of direct interface, such as an 802.11 DSRC interface, a Bluetooth™ interface, and/or other interface. For example, a vehicle can communicate with a user device over a direct communications interface (e.g., using PC5 and/or DSRC), a vehicle can communicate with another vehicle over the direct communications interface, a user device can communicate with another user device over the direct communications interface, a UE (e.g., a vehicle, user device, etc.) can communicate with an RSU over the direct communications interface, an RSU can communicate with another RSU over the direct communications interface, and the like.

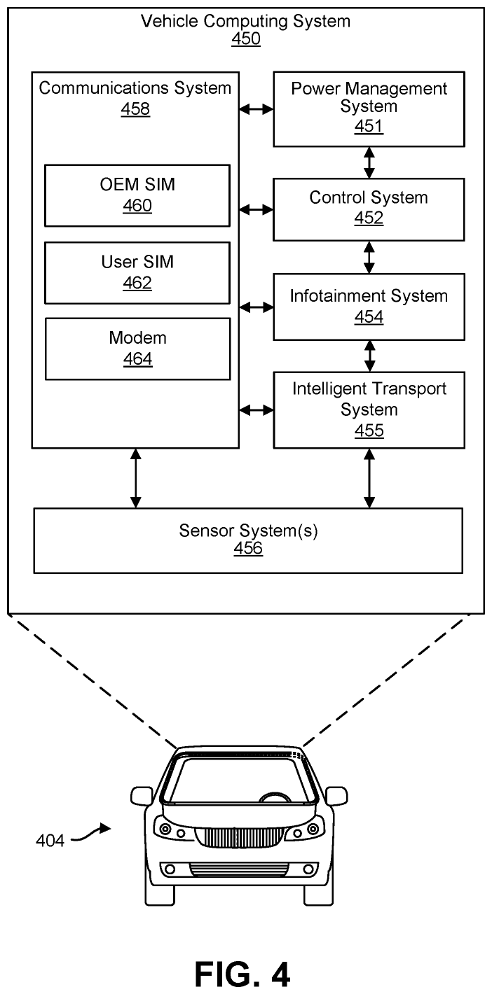

FIG. 4 is a block diagram illustrating an example a vehicle computing system 450 of a vehicle 404. The vehicle 404 is an example of a UE that can communicate with a network (e.g., an eNB, a gNB, a positioning beacon, a location measurement unit, and/or other network entity) over a Uu interface and with other UEs using V2X communications over a PC5 interface (or other device to device direct interface, such as a DSRC interface). As shown, the vehicle computing system 450 can include at least a power management system 451, a control system 452, an infotainment system 454, an intelligent transport system (ITS) 455, one or more sensor systems 456, and a communications system 458. In some cases, the vehicle computing system 450 can include or can be implemented using any type of processing device or system, such as one or more central processing units (CPUs), digital signal processors (DSPs), application specific integrated circuits (ASICs), field programmable gate arrays (FPGAs), application processors (APs), graphics processing units (GPUs), vision processing units (VPUs), Neural Network Signal Processors (NSPs), microcontrollers, dedicated hardware, any combination thereof, and/or other processing device or system.

The control system 452 can be configured to control one or more operations of the vehicle 404, the power management system 451, the computing system 450, the infotainment system 454, the ITS 455, and/or one or more other systems of the vehicle 404 (e.g., a braking system, a steering system, a safety system other than the ITS 455, a cabin system, and/or other system). In some examples, the control system 452 can include one or more electronic control units (ECUs). An ECU can control one or more of the electrical systems or subsystems in a vehicle. Examples of specific ECUs that can be included as part of the control system 452 include an engine control module (ECM), a powertrain control module (PCM), a transmission control module (TCM), a brake control module (BCM), a central control module (CCM), a central timing module (CTM), among others. In some cases, the control system 452 can receive sensor signals from the one or more sensor systems 456 and can communicate with other systems of the vehicle computing system 450 to operate the vehicle 404.

The vehicle computing system 450 also includes a power management system 451. In some implementations, the power management system 451 can include a power management integrated circuit (PMIC), a standby battery, and/or other components. In some cases, other systems of the vehicle computing system 450 can include one or more PMICs, batteries, and/or other components. The power management system 451 can perform power management functions for the vehicle 404, such as managing a power supply for the computing system 450 and/or other parts of the vehicle. For example, the power management system 451 can provide a stable power supply in view of power fluctuations, such as based on starting an engine of the vehicle. In another example, the power management system 451 can perform thermal monitoring operations, such as by checking ambient and/or transistor junction temperatures. In another example, the power management system 451 can perform certain functions based on detecting a certain temperature level, such as causing a cooling system (e.g., one or more fans, an air conditioning system, etc.) to cool certain components of the vehicle computing system 450 (e.g., the control system 452, such as one or more ECUs), shutting down certain functionalities of the vehicle computing system 450 (e.g., limiting the infotainment system 454, such as by shutting off one or more displays, disconnecting from a wireless network, etc.), among other functions.

The vehicle computing system 450 further includes a communications system 458. The communications system 458 can include both software and hardware components for transmitting signals to and receiving signals from a network (e.g., a gNB or other network entity over a Uu interface) and/or from other UEs (e.g., to another vehicle or UE over a PC5 interface, WiFi interface (e.g., DSRC), Bluetooth™ interface, and/or other wireless and/or wired interface). For example, the communications system 458 is configured to transmit and receive information wirelessly over any suitable wireless network (e.g., a 3G network, 4G network, 5G network, WiFi network, Bluetooth™ network, and/or other network). The communications system 458 includes various components or devices used to perform the wireless communication functionalities, including an original equipment manufacturer (OEM) subscriber identity module (referred to as a SIM or SIM card) 460, a user SIM 462, and a modem 464. The SIM 460 can include a hardware SIM, a software-based SIM (or eSIM) (e.g., a programmable SIM card), any combination thereof, and/or other types of SIMs. While the vehicle computing system 450 is shown as having two SIMs and one modem, the computing system 450 can have any number of SIMs (e.g., one SIM or more than two SIMs) and any number of modems (e.g., one modem, two modems, or more than two modems) in some implementations.

A SIM is a device (e.g., an integrated circuit) that can securely store an international mobile subscriber identity (IMSI) number and a related key (e.g., an encryption-decryption key) of a particular subscriber or user. The IMSI and key can be used to identify and authenticate the subscriber on a particular UE. The OEM SIM 460 can be used by the communications system 458 for establishing a wireless connection for vehicle-based operations, such as for conducting emergency-calling (cCall) functions, communicating with a communications system of the vehicle manufacturer (e.g., for software updates, etc.), among other operations. The OEM SIM 460 can be important for the OEM SIM to support critical services, such as eCall for making emergency calls in the event of a car accident or other emergency. For instance, eCall can include a service that automatically dials an emergency number (e.g., “9-1-1” in the United States, “1-1-2” in Europe, etc.) in the event of a vehicle accident and communicates a location of the vehicle to the emergency services, such as a police department, fire department, etc.

The user SIM 462 can be used by the communications system 458 for performing wireless network access functions in order to support a user data connection (e.g., for conducting phone calls, messaging, Infotainment related services, among others). In some cases, a user device of a user can connect with the vehicle computing system 450 over an interface (e.g., over PC5, Bluetooth™, WiFI™ (e.g., DSRC), a universal serial bus (USB) port, and/or other wireless or wired interface). Once connected, the user device can transfer wireless network access functionality from the user device to communications system 458 the vehicle, in which case the user device can cease performance of the wireless network access functionality (e.g., during the period in which the communications system 458 is performing the wireless access functionality). The communications system 458 can begin interacting with a base station to perform one or more wireless communication operations, such as facilitating a phone call, transmitting and/or receiving data (e.g., messaging, video, audio, etc.), among other operations. In such cases, other components of the vehicle computing system 450 can be used to output data received by the communications system 458. For example, the infotainment system 454 (described below) can display video received by the communications system 458 on one or more displays and/or can output audio received by the communications system 458 using one or more speakers.

A modem is a device that modulates one or more carrier wave signals to encode digital information for transmission, and demodulates signals to decode the transmitted information. The modem 464 (and/or one or more other modems of the communications system 458) can be used for communication of data for the OEM SIM 460 and/or the user SIM 462. In some examples, the modem 464 can include a 4G (or LTE) modem and another modem (not shown) of the communications system 458 can include a 5G (or NR) modem. In some examples, the communications system 458 can include one or more Bluetooth™ modems (e.g., for Bluetooth™ Low Energy (BLE) or other type of Bluetooth communications), one or more WiFi™ modems (e.g., for DSRC communications and/or other WiFi communications), wideband modems (e.g., an ultra-wideband (UWB) modem), any combination thereof, and/or other types of modems.

In some cases, the modem 464 (and/or one or more other modems of the communications system 458) can be used for performing V2X communications (e.g., with other vehicles for V2V communications, with other devices for D2D communications, with infrastructure systems for V2I communications, with pedestrian UEs for V2P communications, etc.). In some examples, the communications system 458 can include a V2X modem used for performing V2X communications (e.g., sidelink communications over a PC5 interface or DSRC interface), in which case the V2X modem can be separate from one or more modems used for wireless network access functions (e.g., for network communications over a network/Uu interface and/or sidelink communications other than V2X communications).

In some examples, the communications system 458 can be or can include a telematics control unit (TCU). In some implementations, the TCU can include a network access device (NAD) (also referred to in some cases as a network control unit or NCU). The NAD can include the modem 464, any other modem not shown in FIG. 4, the OEM SIM 460, the user SIM 462, and/or other components used for wireless communications. In some examples, the communications system 458 can include a Global Navigation Satellite System (GNSS). In some cases, the GNSS can be part of the one or more sensor systems 456, as described below. The GNSS can provide the ability for the vehicle computing system 450 to perform one or more location services, navigation services, and/or other services that can utilize GNSS functionality.

In some cases, the communications system 458 can further include one or more wireless interfaces (e.g., including one or more transceivers and one or more baseband processors for each wireless interface) for transmitting and receiving wireless communications, one or more wired interfaces (e.g., a serial interface such as a universal serial bus (USB) input, a lightening connector, and/or other wired interface) for performing communications over one or more hardwired connections, and/or other components that can allow the vehicle 404 to communicate with a network and/or other UEs.

The vehicle computing system 450 can also include an infotainment system 454 that can control content and one or more output devices of the vehicle 404 that can be used to output the content. The infotainment system 454 can also be referred to as an in-vehicle infotainment (IVI) system or an In-car entertainment (ICE) system. The content can include navigation content, media content (e.g., video content, music or other audio content, and/or other media content), among other content. The one or more output devices can include one or more graphical user interfaces, one or more displays, one or more speakers, one or more extended reality devices (e.g., a VR, AR, and/or MR headset), one or more haptic feedback devices (e.g., one or more devices configured to vibrate a seat, steering wheel, and/or other part of the vehicle 404), and/or other output device.

In some examples, the computing system 450 can include the intelligent transport system (ITS) 455. In some examples, the ITS 455 can be used for implementing V2X communications. For example, an ITS stack of the ITS 455 can generate V2X messages based on information from an application layer of the ITS. In some cases, the application layer can determine whether certain conditions have been met for generating messages for use by the ITS 455 and/or for generating messages that are to be sent to other vehicles (for V2V communications), to pedestrian UEs (for V2P communications), and/or to infrastructure systems (for V2I communications). In some cases, the communications system 458 and/or the ITS 455 can obtain car access network (CAN) information (e.g., from other components of the vehicle via a CAN bus). In some examples, the communications system 458 (e.g., a TCU NAD) can obtain the CAN information via the CAN bus and can send the CAN information to a PHY/MAC layer of the ITS 455. The ITS 455 can provide the CAN information to the ITS stack of the ITS 455. The CAN information can include vehicle related information, such as a heading of the vehicle, speed of the vehicle, breaking information, among other information. The CAN information can be continuously or periodically (e.g., every 1 millisecond (ms), every 10 ms, or the like) provided to the ITS 455.

The conditions used to determine whether to generate messages can be determined using the CAN information based on safety-related applications and/or other applications, including applications related to road safety, traffic efficiency, infotainment, business, and/or other applications. In one illustrative example, the ITS 455 can perform lane change assistance or negotiation. For instance, using the CAN information, the ITS 455 can determine that a driver of the vehicle 404 is attempting to change lanes from a current lane to an adjacent lane (e.g., based on a blinker being activated, based on the user veering or steering into an adjacent lane, etc.). Based on determining the vehicle 404 is attempting to change lanes, the ITS 455 can determine a lane-change condition has been met that is associated with a message to be sent to other vehicles that are nearby the vehicle in the adjacent lane. The ITS 455 can trigger the ITS stack to generate one or more messages for transmission to the other vehicles, which can be used to negotiate a lane change with the other vehicles. Other examples of applications include forward collision warning, automatic emergency breaking, lane departure warning, pedestrian avoidance or protection (e.g., when a pedestrian is detected near the vehicle 404, such as based on V2P communications with a UE of the user), traffic sign recognition, among others.

The ITS 455 can use any suitable protocol to generate messages (e.g., V2X messages). Examples of protocols that can be used by the ITS 455 include one or more Society of Automotive Engineering (SAE) standards, such as SAE J2735, SAE J2945, SAE J3161, and/or other standards, which are hereby incorporated by reference in their entirety and for all purposes.

A security layer of the ITS 455 can be used to securely sign messages from the ITS stack that are sent to and verified by other UEs configured for V2X communications, such as other vehicles, pedestrian UEs, and/or infrastructure systems. The security layer can also verify messages received from such other UEs. In some implementations, the signing and verification processes can be based on a security context of the vehicle. In some examples, the security context may include one or more encryption-decryption algorithms, a public and/or private key used to generate a signature using an encryption-decryption algorithm, and/or other information. For example, each ITS message generated by the ITS 455 can be signed by the security layer of the ITS 455. The signature can be derived using a public key and an encryption-decryption algorithm. A vehicle, pedestrian UE, and/or infrastructure system receiving a signed message can verify the signature to make sure the message is from an authorized vehicle. In some examples, the one or more encryption-decryption algorithms can include one or more symmetric encryption algorithms (e.g., advanced encryption standard (AES), data encryption standard (DES), and/or other symmetric encryption algorithm), one or more asymmetric encryption algorithms using public and private keys (e.g., Rivest-Shamir-Adleman (RSA) and/or other asymmetric encryption algorithm), and/or other encryption-decryption algorithm.

In some examples, the ITS 455 can determine certain operations (e.g., V2X-based operations) to perform based on messages received from other UEs. The operations can include safety-related and/or other operations, such as operations for road safety, traffic efficiency, infotainment, business, and/or other applications. In some examples, the operations can include causing the vehicle (e.g., the control system 452) to perform automatic functions, such as automatic breaking, automatic steering (e.g., to maintain a heading in a particular lane), automatic lane change negotiation with other vehicles, among other automatic functions. In one illustrative example, a message can be received by the communications system 458 from another vehicle (e.g., over a PC5 interface, a DSRC interface, or other device to device direct interface) indicating that the other vehicle is coming to a sudden stop. In response to receiving the message, the ITS stack can generate a message or instruction and can send the message or instruction to the control system 452, which can cause the control system 452 to automatically break the vehicle 404 so that it comes to a stop before making impact with the other vehicle. In other illustrative examples, the operations can include triggering display of a message alerting a driver that another vehicle is in the lane next to the vehicle, a message alerting the driver to stop the vehicle, a message alerting the driver that a pedestrian is in an upcoming cross-walk, a message alerting the driver that a toll booth is within a certain distance (e.g., within 1 mile) of the vehicle, among others.

In some examples, the ITS 455 can receive a large number of messages from the other UEs (e.g., vehicles, RSUs, etc.), in which case the ITS 455 will authenticate (e.g., decode and decrypt) each of the messages and/or determine which operations to perform. Such a large number of messages can lead to a large computational load for the vehicle computing system 450. In some cases, the large computational load can cause a temperature of the computing system 450 to increase. Rising temperatures of the components of the computing system 450 can adversely affect the ability of the computing system 450 to process the large number of incoming messages. One or more functionalities can be transitioned from the vehicle 404 to another device (e.g., a user device, a RSU, etc.) based on a temperature of the vehicle computing system 450 (or component thereof) exceeding or approaching one or more thermal levels. Transitioning the one or more functionalities can reduce the computational load on the vehicle 404, helping to reduce the temperature of the components. A thermal load balancer can be provided that enable the vehicle computing system 450 to perform thermal based load balancing to control a processing load depending on the temperature of the computing system 450 and processing capacity of the vehicle computing system 450.

The computing system 450 further includes one or more sensor systems 456 (e.g., a first sensor system through an Nth sensor system, where N is a value equal to or greater than 0). When including multiple sensor systems, the sensor system(s) 456 can include different types of sensor systems that can be arranged on or in different parts the vehicle 404. The sensor system(s) 456 can include one or more camera sensor systems, LIDAR sensor systems, radio detection and ranging (RADAR) sensor systems, Electromagnetic Detection and Ranging (EmDAR) sensor systems, Sound Navigation and Ranging (SONAR) sensor systems, Sound Detection and Ranging (SODAR) sensor systems, Global Navigation Satellite System (GNSS) receiver systems (e.g., one or more Global Positioning System (GPS) receiver systems), accelerometers, gyroscopes, inertial measurement units (IMUs), infrared sensor systems, laser rangefinder systems, ultrasonic sensor systems, infrasonic sensor systems, microphones, any combination thereof, and/or other sensor systems. It should be understood that any number of sensors or sensor systems can be included as part of the computing system 450 of the vehicle 404.

While the vehicle computing system 450 is shown to include certain components and/or systems, one of ordinary skill will appreciate that the vehicle computing system 450 can include more or fewer components than those shown in FIG. 4. For example, the vehicle computing system 450 can also include one or more input devices and one or more output devices (not shown). In some implementations, the vehicle computing system 450 can also include (e.g., as part of or separate from the control system 452, the infotainment system 454, the communications system 458, and/or the sensor system(s) 456) at least one processor and at least one memory having computer-executable instructions that are executed by the at least one processor. The at least one processor is in communication with and/or electrically connected to (referred to as being “coupled to” or “communicatively coupled”) the at least one memory. The at least one processor can include, for example, one or more microcontrollers, one or more central processing units (CPUs), one or more field programmable gate arrays (FPGAs), one or more graphics processing units (GPUs), one or more application processors (e.g., for running or executing one or more software applications), and/or other processors. The at least one memory can include, for example, read-only memory (ROM), random access memory (RAM) (e.g., static RAM (SRAM)), electrically erasable programmable read-only memory (EEPROM), flash memory, one or more buffers, one or more databases, and/or other memory. The computer-executable instructions stored in or on the at least memory can be executed to perform one or more of the functions or operations described herein.

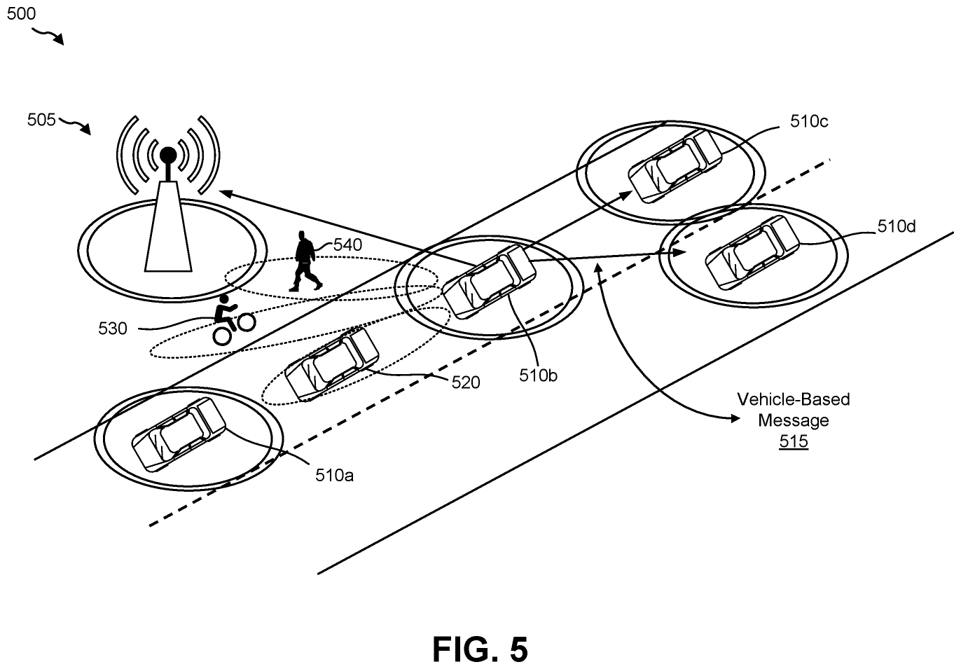

FIG. 5 is a diagram illustrating an example of a system 500 for sensor sharing in wireless communications (e.g., V2X communications). In FIG. 5, the system 500 is shown to include a plurality of equipped (e.g., V2X capable) network devices. The plurality of equipped network devices includes vehicles (e.g., automobiles) 510a, 510b, 510c, 510d, and an RSU 505. Also shown are a plurality of non-equipped network devices, which include a non-equipped vehicle 520, a VRU (e.g., a bicyclist) 530, and a pedestrian 540. The system 500 may comprise more or less equipped network devices and/or more or less non-equipped network devices, than as shown in FIG. 5. In addition, the system 500 may comprise more or less different types of equipped network devices (e.g., which may include equipped UEs) and/or more or less different types of non-equipped network devices (e.g., which may include non-equipped UEs) than as shown in FIG. 5. In addition, in one or more examples, the equipped network devices may be equipped with heterogeneous capability, which may include, but is not limited to, C-V2X/DSRC capability, 4G/5G cellular connectivity, GPS capability, camera capability, radar capability, and/or LIDAR capability.

The plurality of equipped network devices may be capable of performing V2X communications. In addition, at least some of the equipped network devices are configured to transmit and receive sensing signals for radar (e.g., RF sensing signals) and/or LIDAR (e.g., optical sensing signals) to detect nearby vehicles and/or objects. Additionally or alternatively, in some cases, at least some of the equipped network devices are configured to detect nearby vehicles and/or objects using one or more cameras (e.g., by processing images captured by the one or more cameras to detect the vehicles/objects). In one or more examples, vehicles 510a, 510b, 510c, 510d and RSU 505 may be configured to transmit and receive sensing signals of some kind (e.g., radar and/or LIDAR sensing signals).

In some examples, some of the equipped network devices may have higher capability sensors (e.g., GPS receivers, cameras, RF antennas, and/or optical lasers and/or optical sensors) than other equipped network devices of the system 500. For example, vehicle 510b may be a luxury vehicle and, as such, have more expensive, higher capability sensors than other vehicles that are economy vehicles. In one illustrative example, vehicle 510b may have one or more higher capability LIDAR sensors (e.g., high capability optical lasers and optical sensors) than the other equipped network devices in the system 500. In one illustrative example, a LIDAR of vehicle 510b may be able to detect a VRU (e.g., cyclist) 530 and/or a pedestrian 540 with a large degree of confidence (e.g., a seventy percent degree of confidence). In another example, vehicle 510b may have higher capability radar (e.g., high capability RF antennas) than the other equipped network devices in the system 500. For instance, the radar of vehicle 510b may be able to detect the VRU (e.g., cyclist) 530 and/or pedestrian 540 with a degree of confidence (e.g., an eight-five percent degree of confidence). In another example, vehicle 510b may have higher capability camera (e.g., with higher resolution capabilities, higher frame rate capabilities, better lens, etc.) than the other equipped network devices in the system 500.

During operation of the system 500, the equipped network devices (e.g., RSU 505 and/or at least one of the vehicles 510a, 510b, 510c, 510d) may transmit and/or receive sensing signals (e.g., RF and/or optical signals) to sense and detect vehicles (e.g., vehicles 510a, 510b, 510c. 510d, and 520) and/or objects (e.g., VRU 530 and pedestrian 540) located within and surrounding the road. The equipped network devices (e.g., RSU 505 and/or at least one of the vehicles 510a, 510b, 510c, 510d) may then use the sensing signals to determine characteristics (e.g., motion, dimensions, type, heading, and speed) of the detected vehicles and/or objects. The equipped network devices (e.g., RSU 505 and/or at least one of the vehicles 510a, 510b, 510c, 510d) may generate at least one vehicle-based message 515 (e.g., a V2X message, such as a Sensor Data Sharing Message (SDSM), a Basic Safety Message (BSM), a Cooperative Awareness Message (CAM), Collective Perception Messages (CPMs), and/or other type of message) including information related to the determined characteristics of the detected vehicles and/or objects.

The vehicle-based message 515 may include information related to the detected vehicle or object (e.g., a position of the vehicle or object, an accuracy of the position, a speed of the vehicle or object, a direction in which the vehicle or object is traveling, and/or other information related to the vehicle or object), traffic conditions (e.g., low speed and/or dense traffic, high speed traffic, information related to an accident, etc.), weather conditions (e.g., rain, snow, etc.), message type (e.g., an emergency message, a non-emergency or “regular” message), etc.), road topology (line-of-sight (LOS) or non-LOS (NLOS), etc.), any combination, thereof, and/or other information. In some examples, the vehicle-based message 515 may also include information regarding the equipped network device's preference to receive vehicle-based messages from other certain equipped network devices. In some cases, the vehicle-based message 515 may include the current capabilities of the equipped network device (e.g., vehicles 510a, 510b, 510c, 510d), such as the equipped network device's sensing capabilities (which can affect the equipped network device's accuracy in sensing vehicles and/or objects), processing capabilities, the equipped network device's thermal status (which can affect the vehicle's ability to process data), and the equipped network device's state of health.

In some aspects, the vehicle-based message 515 may include a dynamic neighbor list (also referred to as a Local Dynamic Map (LDM) or a dynamic surrounding map) for each of the equipped network devices (e.g., vehicles 510a, 510b, 510c, 510d and RSU 505). For example, each dynamic neighbor list can include a listing of all of the vehicles and/or objects that are located within a specific predetermined distance (or radius of distance) away from a corresponding equipped network device. In some cases, each dynamic neighbor list includes a mapping, which may include roads and terrain topology, of all of the vehicles and/or objects that are located within a specific predetermined distance (or radius of distance) away from a corresponding equipped network device.

In some implementations, the vehicle-based message 515 may include a specific use case or safety warning, such as a do-not-pass warning (DNPW) or a forward collision warning (FCW), related to the current conditions of the equipped network device (e.g., vehicles 510a, 510b, 510c, 510d). In some examples, the vehicle-based message 515 may be in the form of a standard Basic Safety Message (BSM), a Cooperative Awareness Message (CAM), a Collective Perception Message (CPM), a Sensor Data Sharing Message (SDSM) (e.g., SAE J3224 SDSM), and/or other format.

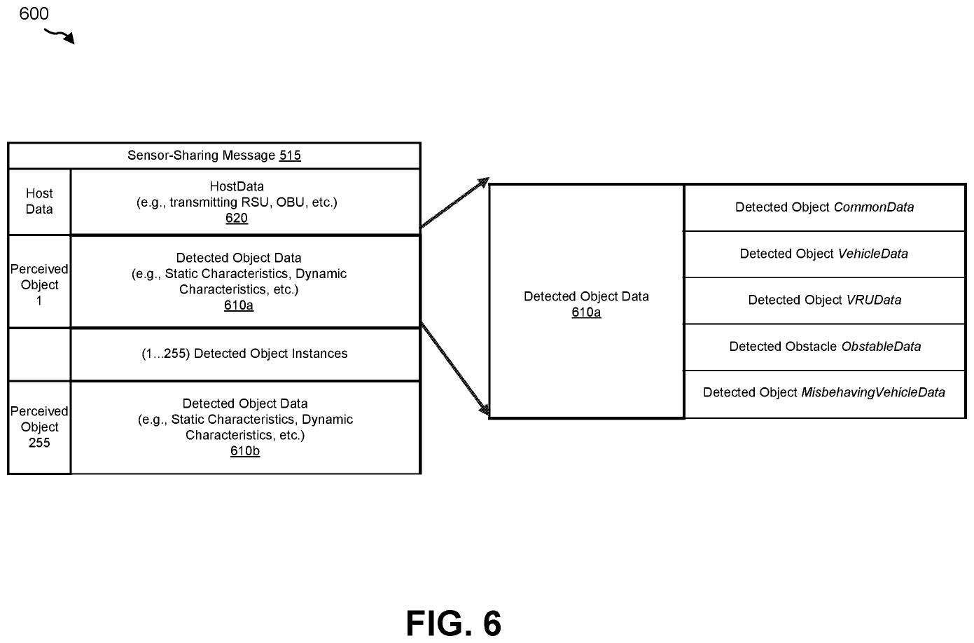

FIG. 6 is a diagram 600 illustrating an example of a vehicle-based message (e.g., vehicle-based message 515 of FIG. 5). The vehicle-based message 515 is shown as a sensor-sharing message (e.g., an SDSM), but can include a BSM, a CAM, a CPM, or other vehicle-based message as noted herein. In FIG. 6, the vehicle-based message 515 is shown to include HostData 620 and Detected Object Data 610a, 610b. The HostData 620 of the vehicle-based message 515 may include information related to the transmitting device (e.g., the transmitting equipped network entity, such as RSU 505 or an onboard unit (OBU), such as on vehicles 510a, 510b, 510c, 510d) of the vehicle-based message 515. The Detected Object Data 610a, 610b of the vehicle-based message 515 may include information related to the detected vehicle or object (e.g., static or dynamic characteristics related to the detected vehicle or object, and/or other information related to the detected vehicle or object). The Detected Object Data 610a. 610b may specifically include Detected Object CommonData, Detected Object VehicleData, Detected Object VRUData, Detected Obstacle ObstacleData, and Detected Object Misbehaving VehicleData.

These vehicle-based messages 515 are beneficial because they can provide an awareness and understanding to the equipped network devices (e.g., vehicles 510a, 510b, 510c, 510d of FIG. 5) of upcoming potential road dangers (e.g., unforeseen oncoming vehicles, accidents, and road conditions).

As previously mentioned, vehicles can share sensor information with each other to obtain situational awareness of their environment. Sensor sharing is addressed in the SAE standards. SAE J3224 addresses V2X sensor sharing for cooperative and automated driving. Specifically, SAE J3224 defines the V2X message structure and information elements for RSUs and vehicles to exchange information with each other regarding detected objects and road users.

SAE J3224 also provides for raw sensor sharing, which involves a high resolution video streaming exchange performed between vehicles, in real time, to detect blind spots. In some cases, a RSU and/or other vehicles may be able to provide blind spot specific sensor information to a remote vehicle. However, raw sensor sharing involves streaming large amounts of high resolution video and, as such, raw sensor sharing requires a very high bandwidth. A remote vehicle will need to be able to support this very high bandwidth requirement in order to be able to receive the raw sensor data from the surrounding vehicles.

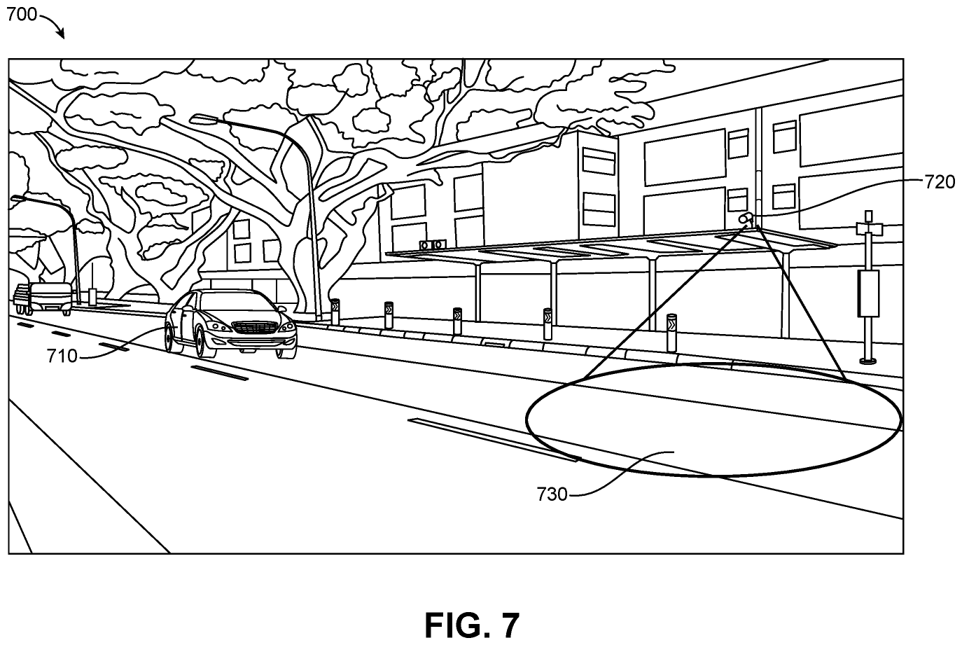

FIG. 7 shows an example of raw sensor sharing for a blind spot area. In particular, FIG. 7 is a diagram illustrating an example of raw sensor sharing for a blind spot area 700 (e.g., shown in the form of a spot beam) in front of a bus stop, in the case of a stopped bus in front of the bus stop. In FIG. 7, when a bus is stopped in front of the bus stop, the bus may be blocking the view of a vehicle 710 of the blind spot area 730. A camera 720 may be mounted above the bus stop and may obtain images and/or video (e.g., raw sensor data) of the blind spot area 730. The camera 720 can send these images and/or stream the video in real time to the vehicle 710, such that the vehicle 710 can obtain situational awareness of activity within the blind spot area 730, when a bus is stopped in front of the bus stop.

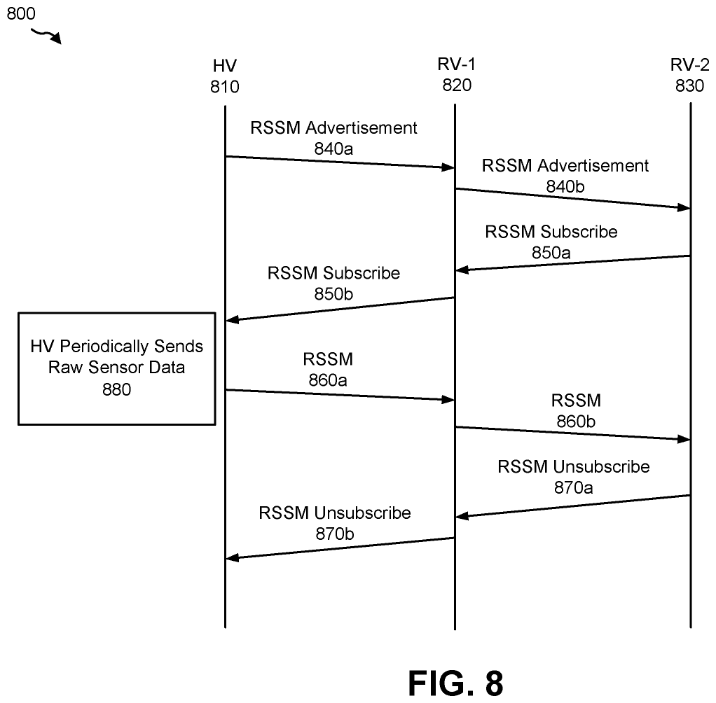

Raw sensor sharing can require a large amount of signaling amongst the vehicles. This large amount of signaling can require large amounts of bandwidth and power. FIG. 8 is a diagram illustrating an example of signaling 800 for raw sensor sharing (e.g., for relaying of the raw sensor data amongst vehicles 810, 820, 830). In particular, FIG. 8 shows signaling 800 for a vehicle 810 sharing its raw sensor data with other vehicles 820, 830.

During operation for the raw sensor sharing, a vehicle 810, such as a host vehicle (HV), can send (transmit) a raw sensing sharing message (RSSM) advertisement 840a, which can include an advertisement for sharing its raw sensor data, to another vehicle 820. The vehicle 820 may be a first remote vehicle (RV-1), and may alternatively be in form of an RSU. After the vehicle 820 (RV-1) receives the RSSM advertisement 840a, the vehicle 820 (RV-1) can send (transmit) a RSSM advertisement 840b to another vehicle 830, such as a second remote vehicle (RV-2), which may also alternatively be in the form of an RSU.

After the vehicle 830 (RV-2) receives the RSSM advertisement 840b, the vehicle 830 (RV-2) can send (transmit) an RSSM subscribe 850a, which can indicate a subscription to receive the raw sensor data, to vehicle 820 (RV-1). After vehicle 820 (RV-1) receives the RSSM subscribe 850a, the vehicle 820 (RV-1) can send (transmit) an RSSM subscribe 850b to vehicle 810 (HV).

After the vehicle 810 (HV) receives the RSSM subscribe 850b, the vehicle 810 (HV) can periodically send (transmit) its raw sensor data 880 to the vehicles 820, 830. For example, the vehicle 810 (HV) can send (transmit) an RSSM 860a, which contains its raw sensor data, to vehicle 820 (RV-1). After vehicle 820 (RV-1) receives the RSSM 860a, the vehicle 820 (RV-1) can send (transmit) an RSSM 860b, which contains the raw sensor data from vehicle 810 (HV), to vehicle 830 (RV-2).

After vehicle 830 (RV-2) receives the RSSM 860b, the vehicle 830 (RV-2) can send (transmit) a RSSM unsubscribe 870a, which can indicate a cancelation in the subscription to receive the raw sensor data, to vehicle 830 (RV-2). After the vehicle 830 (RV-2) receives the RSSM unsubscribe 870a, the vehicle 830 (RV-2) can send (transmit) an RSSM unsubscribe 870b to vehicle 810 (HV). After the vehicle 810 (HV) receives the RSSM unsubscribe 870b, the vehicle 810 (HV) can stop sending (transmitting) its raw sensor data to the other vehicles 820, 830.

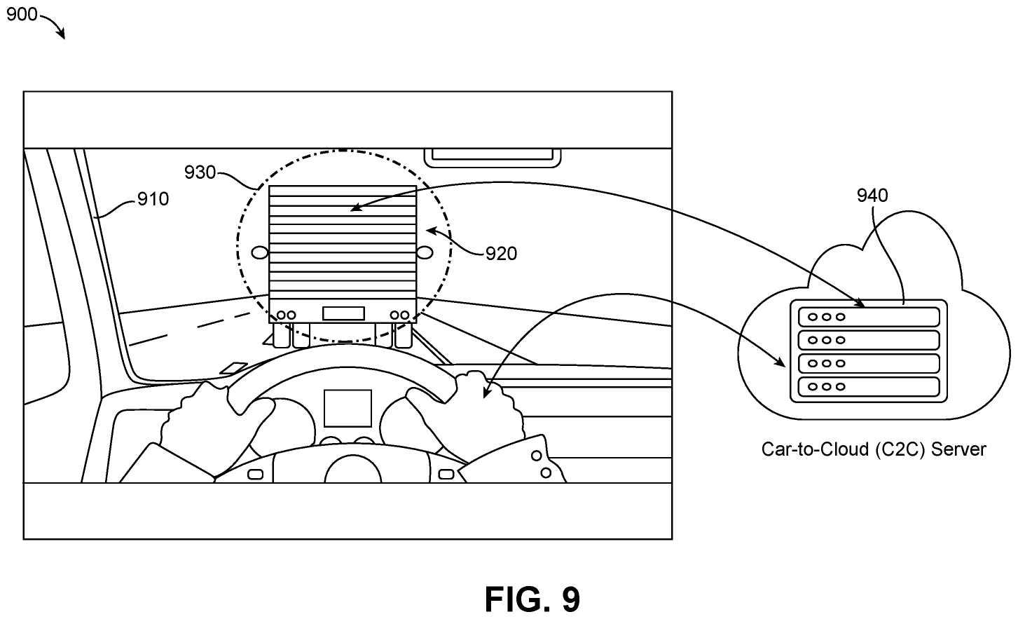

As previously mentioned, there can be cases where vehicles may need information (e.g., a visual view, such as a panoramic visual view of an ROI) to obtain situational awareness of blind spots in their environment. FIGS. 9, 10, and 11 show examples of scenarios where a vehicle has a blind spot and can need information (e.g., panoramic visual view of an ROI) regarding the blind spot area (e.g., the ROI). In particular, FIG. 9 is a diagram illustrating an example scenario 900 where a vehicle's 910 view of the road is blocked by a truck 920. In FIG. 9, the view of the vehicle 910 of the road in front of the vehicle 910 is blocked by the truck 920 driving directly in front of the vehicle 910 on the road. As such, the vehicle 910 is unable to see (view) what is located in front of the truck 920. Information regarding what is located in front of the truck 920 can provide awareness to the vehicle 910 of road and traffic conditions, such that the vehicle 910 can decide to take proactive safety measures. As such, the truck 920 can provide information regarding what is located in front of the truck 920 to a server, such as a car-to-cloud (C2C) server 940. The C2C server 940 can then provide this information to the vehicle 910.

It can be beneficial to the vehicle 910 if the vehicle 910 is provided (e.g., via the C2C server 940) with a panoramic visual view of the ROI 930 (e.g., denoted by a dashed circle in FIG. 9), which is the blind spot area of where the truck 920 obstructs the view of the vehicle 910. The panoramic visual view of the ROI 930 should be provided to the vehicle 910 (e.g., by the C2C server 940) as the ROI 930 would be viewed by the vehicle 910, not as the ROI 930 would be viewed by the truck 920. As such, the panoramic visual view of the ROI 930 provided to the vehicle 910 should be a zoomed-out version of the view of the ROI 930 as viewed by the truck 920.

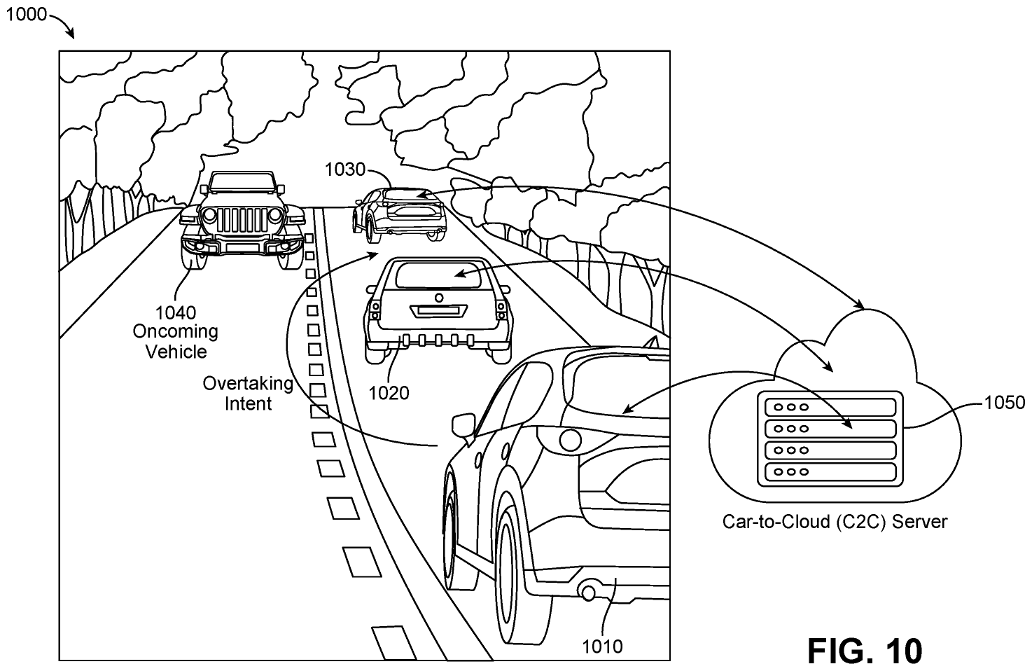

FIG. 10 is a diagram illustrating an example scenario 1000 where a vehicle 1010 desires to overtake (pass) another vehicle 1020 in a two-lane road, but the vehicle 1010 has a blocked view of the road ahead. In FIG. 10, the vehicle 1010 wants to pass the vehicle 1020, but due to a blocked view, the vehicle 1010 cannot see a vehicle 1030 driving in front of the vehicle 1020 and cannot see an oncoming vehicle 1040 approaching in the opposing lane of the road. As such, the vehicle 1010 is unaware of the oncoming vehicle 1040.

The vehicles 1020, 1030 can provide information regarding their view of the road to a server, such as a C2C server 1050. The C2C server 1050 can then provide this information to the vehicle 1010. It can be beneficial to the vehicle 1010 if the vehicle 1010 is provided (e.g., via the C2C server 1050) with a panoramic visual view of the road the vehicle 1020 is viewing, such that the vehicle 1010 can be aware of the oncoming vehicle 1040. The panoramic visual view of the road should be provided to the vehicle 1010 (e.g., by the C2C server 1050) as the road would be viewed by the vehicle 1010, not as the road would be viewed by the vehicle 1020. As such, the panoramic visual view of the road provided to the vehicle 1010 should be a zoomed-out version of the view of the road as viewed by the vehicle 1020.

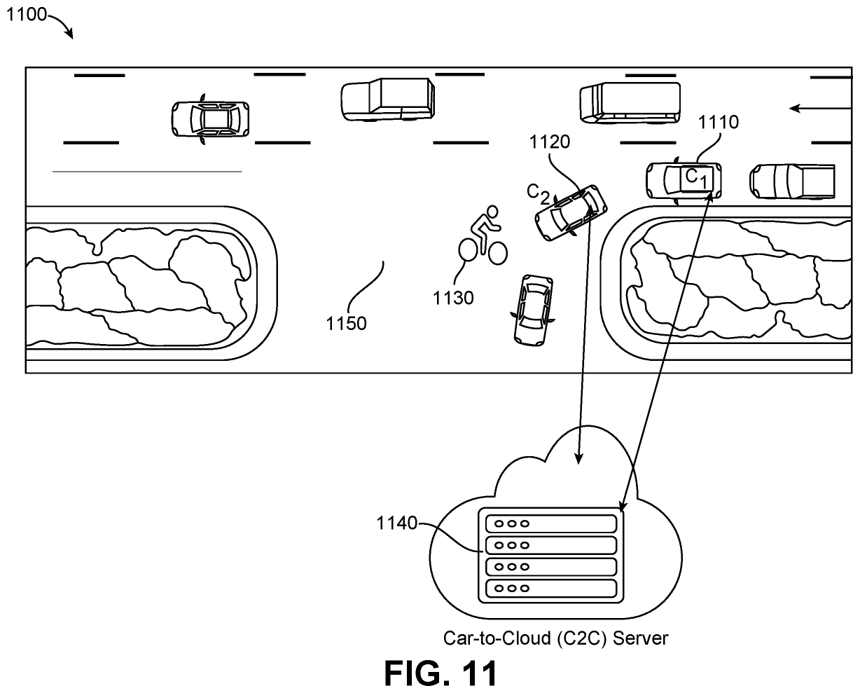

FIG. 11 is a diagram illustrating an example scenario 1100 where a vehicle C1 1110 has a blocked view of an upcoming intersection 1150 in the road. In FIG. 11, the vehicle C1 1110 is approaching the intersection 1150, and is planning to take a left turn at the intersection 1150 of the road. However, the vehicle C1 1110 is unaware of the bicyclist 1130 located in the intersection 1150 because vehicle C2 1120 is blocking the view of the intersection 1150 of the vehicle C1 1110. Th vehicle C2 1120 is able to view the bicyclist 1130 in the intersection 1150.

The vehicle C2 1120 can provide information regarding its view of the intersection 1150 to a server, such as a C2C server 1140. The C2C server 1140 can provide this information to the vehicle C1 1110. It can be beneficial to the vehicle C1 1110 if the vehicle C1 1110 is provided (e.g., via the C2C server 1140) with a panoramic visual view of the intersection 1150 of the road the vehicle C2 1120 is viewing, such that the vehicle C1 1110 can be aware of the bicyclist 1130 located in the intersection 1150. The panoramic visual view of the intersection 1150 should be provided to the vehicle C1 1110 (e.g., by the C2C server 1050) as the intersection 1150 would be viewed by the vehicle C1 1110, not as the intersection 1150 would be viewed by the vehicle C2 1120. The panoramic visual view of the intersection 1150 provided to the vehicle C1 1110 should be a zoomed-out version of the view of the intersection 1150 as viewed by the vehicle C2 1120.

In one or more aspects, the systems and techniques provide a cloud-based virtual view for V2V applications. The systems and techniques can allow for a server (e.g., a C2C server) to provide a panoramic visual view, which includes blind spot specific information within an ROI, to a vehicle with a blocked view. In all of the scenarios shown in FIGS. 9, 10, and 11, all of the vehicles are connected to a C2C server (e.g., C2C server 940 in FIG. 9, C2C server 1050 in FIG. 10, and C2C server 1140 in FIG. 11), which has access to sensor information shared amongst the vehicles. The systems and techniques provide procedures and associated signaling required for the C2C server to be able to stitch the visual information obtained from all of the vehicles and to present a panoramic visual view from the point of view of the requesting (blocked) vehicle. The signaling aspects disclosed emphasize stitching aspects for sensor fusion.

In one or more aspects, the systems and techniques can provide a process for generating a panoramic visual view on a specific ROI. In one or more examples, the process can involve a first vehicle requesting from a server (e.g., a C2C server) a panoramic visual view on a specific ROI (e.g., ROI 930 of FIG. 9, the road ahead of vehicle 1020 in FIG. 10, and/or the intersection 1150 of FIG. 11), such as a blind spot area for the first vehicle.

In one or more examples, with reference to FIG. 9, for the request, the vehicle 910 (e.g., the first vehicle) may provide an ROI (e.g., ROI 930) that the vehicle 910 would like to have a panoramic view. In some examples, the requested ROI (e.g., ROI 930) can be of any shape (e.g., a circle, square rectangle, triangle, polygon, etc.). In one or more examples, the vehicle 910 can provide the ROI (e.g., ROI 930) as image coordinates (e.g., coordinates for the top left most vertex and the bottom right most vertex, in the case of a rectangle or square ROI).

In one or more examples, for the signaling for the request of a panoramic view by the vehicle (e.g., the first vehicle), the vehicle can explicitly provide a raw and/or compressed image along with the ROI coordinates to the C2C server. Based on this information, the C2C server can infer the part of the view that the vehicle wants to replace with a panoramic view.

In some examples, for the signaling for the request of a panoramic view by the vehicle (e.g., the first vehicle), the vehicle may provide its location, automobile make and model, camera rotation (e.g., camera extrinsic parameters), and/or camera intrinsic parameters (e.g., focal length, width and/or height of image, camera principal point, and/or lens distortion) along the ROI coordinates to the C2C server. Based on the vehicle location information, camera information, and/or the ROI coordinates; the C2C server can autonomously determine the ROI that the vehicle is interested in (e.g., by using map information). For example, the C2C server can use map information to first determine the view that the vehicle is likely to see. By using the provided ROI coordinates, the C2C server can determine the part of the view that the vehicle wants to replace with a panoramic view.

For the process for generating a panoramic visual view on a specific ROI, the server may request the first vehicle and other vehicles (e.g., a second vehicle, a third vehicle, and a fourth vehicle), which are located in the vicinity of the first vehicle, to provide visual key points and associated feature descriptors of their respective views. In one or more examples, based on a current position and/or pose of the vehicle, the C2C server can determine other vehicles that can provide an informative panoramic view of the ROI as requested by the first vehicle.

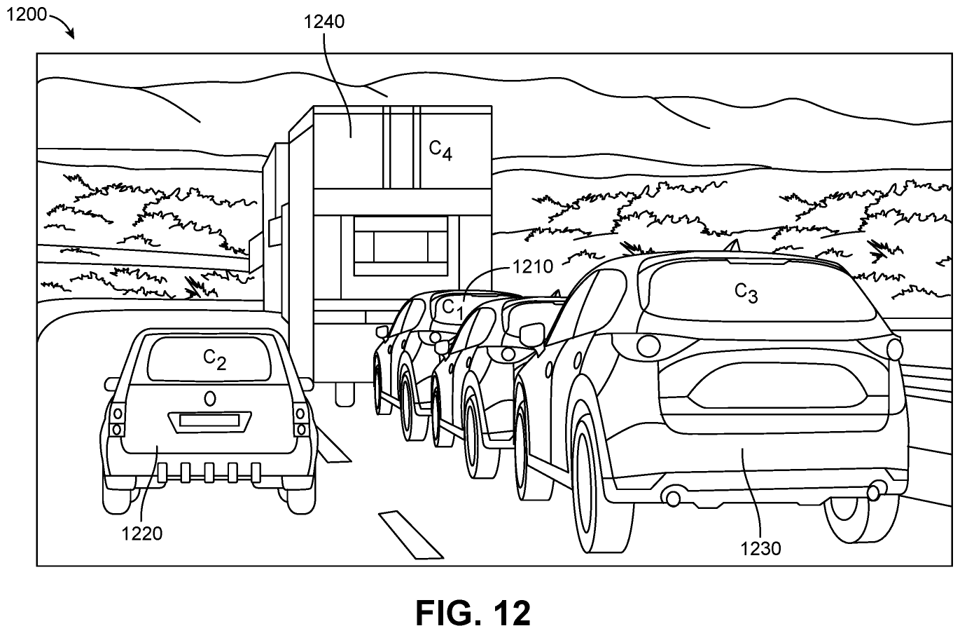

FIG. 12 shows an example scenario that can be used to describe details of the request for the visual key points and the associated feature descriptors. In particular, FIG. 12 is a diagram illustrating an example scenario 1200 where a vehicle C1 1210 is requesting (e.g., a C2C server) a view of an ROI (e.g., a view of road in front of truck C4 1240). In FIG. 12, the view of the vehicle C1 1210 of the road in front of the vehicle C1 1210 is blocked by the truck C4 1240 driving directly in front of the vehicle C1 1210 on the road. As such, the vehicle C1 1210 is unable to see (view) what is located in front of the truck C4 1240. Information related to what is located in front of the truck C4 1240 can provide awareness to the vehicle C1 1210 of road and traffic conditions, such that the vehicle C1 1210 can decide to take proactive safety measures.

In one or more examples, after the C2C server receives the request from the vehicle C1 1210 for a view of the ROI (e.g., the view of road in front of truck C4 1240), the C2C server can determine that vehicle C2 1220, vehicle C3 1230, and vehicle C4 1240 are potential candidate vehicles that can provide a panoramic view of the ROI. The C2C server can request the requesting vehicle (e.g., vehicle C1 1210) and the other vehicles (e.g., the vehicle C2 1220, the vehicle C3 1230, and the vehicle C4 1240) to provide their visual key points and associated feature descriptors determined from images (or views) captured by the requesting vehicles and the other vehicles.

In one or more examples, the request from the C2C server may further include the key point detection method (e.g., for the visual key points). The key point detection method may be, but is not limited to, a Harris corner detector, a features from an accelerated segment test (FAST), and/or a speeded up robust features (SURF). In one or more examples, the request from the C2C server may further include one or more types of feature descriptors of the key points that may include, but is not limited to, a binary robust independent elementary features (BRIEF), an orientated fast and rotated BRIEF (ORB), and/or a SURF. In one or more examples, the request from the C2C server may further include the number of key points and associated feature descriptors to be provided by the vehicles.

In some examples, the request from the C2C server may further include the number (N) of key points is based on an intensity metric for each key point, specified as the sharpness of a corner, as in a Harris corner measure. For example, the key points corresponding to the first N number of the highest corners may be requested by the C2C server.

In one or more examples, the request from the C2C server may further include that the requested key points are to be uniformly sampled in the image space. In one or more examples, the request from the C2C server may further include a request for the raw and/or compressed image itself. In one or more examples, the request from the C2C server may further include a request for the intrinsic parameters of the camera of the vehicle. The intrinsic parameters of the camera may include, but are not limited to, the focal length, the principal point, the lens distortion, and/or the image size including the width and the height.

For the process for generating a panoramic visual view on a specific ROI, the C2C server may match the key points and feature descriptors received from the other vehicles (e.g., a second vehicle, a third vehicle, and a fourth vehicle) with the key points and descriptors received from the first vehicle. In one or more examples, the C2C server can use the key points and feature descriptors obtained from the other vehicles (e.g., the vehicle C2 1220, the vehicle C3 1230, and the vehicle C4 1240 of FIG. 12) to match with the key points and feature descriptors obtained from the first vehicle (e.g., vehicle C1 1210).

For the process for generating a panoramic visual view on a specific ROI, the server can determine appropriate vehicles (e.g., only the second vehicle and third vehicle, not the fourth vehicle) that can provide a panoramic view of the ROI requested by the first vehicle. For example, based on the matching, the C2C server can determine one or more of the other vehicles (e.g., the vehicle C2 1220, the vehicle C3 1230, and the vehicle C4 1240) that can provide the best view of the ROI for the first vehicle (e.g., vehicle C1 1210). In some examples, the determined vehicles that can provide the best view of the ROI may be the vehicle C2 1220 and the vehicle C3 1230 (e.g., not vehicle C4 1240).

The C2C server may then determine or infer a mapping (e.g., a homography) between the first vehicle and each of the appropriate vehicles. For example, the C2C server can determine or infer a homography between the first vehicle and second vehicle, and a homography between the first vehicle and third vehicle. In some cases, the corresponding points obtained from the matched descriptors can be used to determine the homography between the views of first vehicle and the other vehicles (based on the images captured by the first vehicle and other vehicles). For instance, because the corresponding points from the matched descriptors map to the same 3D point, a mapping or transformation (e.g., homography) between two views (including a first image from the first vehicle and a second image from another vehicle) can be obtained from a mapping between the 3D point and the corresponding point of the first image and a mapping between the 3D point and the corresponding point of the second image. In one illustrative example, the homograpy between the first vehicle and second vehicle (H₁₂) and the homograpy between the first vehicle and third vehicle (H₁₃) can be determined by the C2C server.

The C2C server may then use the inferred mappings (e.g., homographies) to combine (e.g., stitch together) an image including a panoramic visual view that includes the ROI to generate a combined image (e.g., a stitched image). For example, by using the first vehicle (e.g., vehicle C1 1210) view as a reference, and using the views of the second vehicle (e.g., the vehicle C2 1220) and the third vehicle (e.g., the vehicle C3 1230), a stitched image can be determined by the C2C server as:

$$Is = ( ∼ ROI ) + {H}_{12} {I}_{2} ( R O I ) + {H}_{13} {I}_{3} ( R OI ) ,$$

where Is is the stitched image; I₁(˜ROI) is the view of the first vehicle not including the ROI; and I₂ and I₃ are the views of the second and third vehicles, respectively.

In one or more examples, the C2C server can use the transformation H₁₂I₂ (ROI)+H₁₃I₃ (ROI) to replace the pixels in the ROI of the first vehicle's image I₁ to generate the stitched image for the first vehicle. The C2C server may then provide the generated stitched image to the first vehicle.

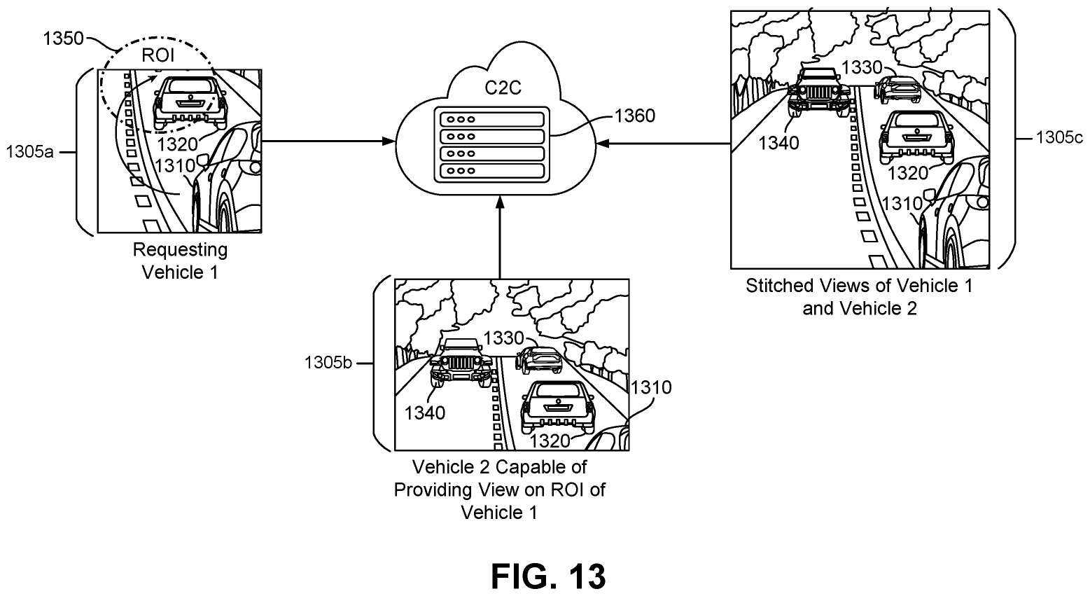

FIG. 13 shows an example of generating the stitched image for a vehicle 1310 (e.g., a first vehicle). In particular, FIG. 13 is a diagram illustrating an example of generating a stitched image 1305c (as an example of a combined image) that includes a view of an ROI 1350 for a vehicle 1310. In FIG. 13, three views of the road are shown in images 1305a, 1305b, and 1305c. As shown in the first view of the image 1305a, the vehicle 1310 desires to overtake (pass) another vehicle 1320 in a two-lane road. However, the vehicle 1310 has a blocked view of the road ahead and, due to the blocked view, the vehicle 1310 (e.g., camera or other sensor of the vehicle, a driver of the vehicle, etc.) cannot see a vehicle 1330 (shown in the scene depicted in the image 1305b) driving in front of the vehicle 1320 and cannot see an oncoming vehicle 1340 (shown in the scene depicted in the image 1305b) approaching in the opposing lane of the road. As such, the vehicle 1310 is unaware of the oncoming vehicle 1340.

The vehicle 1310 (e.g., first vehicle, which is a requesting vehicle) can send a request (which can be referred to as a view request) to the C2C server 1360 to provide a panoramic visual view of the ROI 1350. Once the C2C server 1360 receives the request, the C2C server 1360 can request the vehicle 1310 (e.g., first vehicle) and other nearby vehicles (e.g., vehicles 1320, 1330, 1340) located in the vicinity of the vehicle 1310 to provide the visual key points and associated feature descriptors of their views to the C2C server 1360. After the C2C server 1360 receives all of the requested visual key points and associated feature descriptors, the C2C server 1360 can use the obtained visual key points and associated feature descriptors from the vehicles 1320, 1330, 1340 to match with the obtained visual key points and associated feature descriptors from vehicle 1310.

Based on the matching, the C2C server 1360 can determine the appropriate vehicles (e.g., vehicle 1320) that can provide a panoramic view in the ROI 1350 requested by the vehicle 1310. The scene depicted in the image 1305b shows how vehicle 1320 (e.g., vehicle 2) is capable of providing a view of the ROI 1350 requested by vehicle 1310 (e.g., vehicle 1).

The C2C server 1360 can infer the mapping (e.g., homography) between the vehicle 1310 and the vehicle 1320. The C2C server 1360 can then use the inferred mapping (e.g., homography) to stitch views of vehicle 1310 and vehicle 1320 together to generate a combined image (e.g., a stitched image), such as shown in the scene depicted in the image 1305c. The C2C server 1360 can then provide the combined image to the vehicle 1310. The combined image is a panoramic visual view of the road as would be viewed by the vehicle 1310.

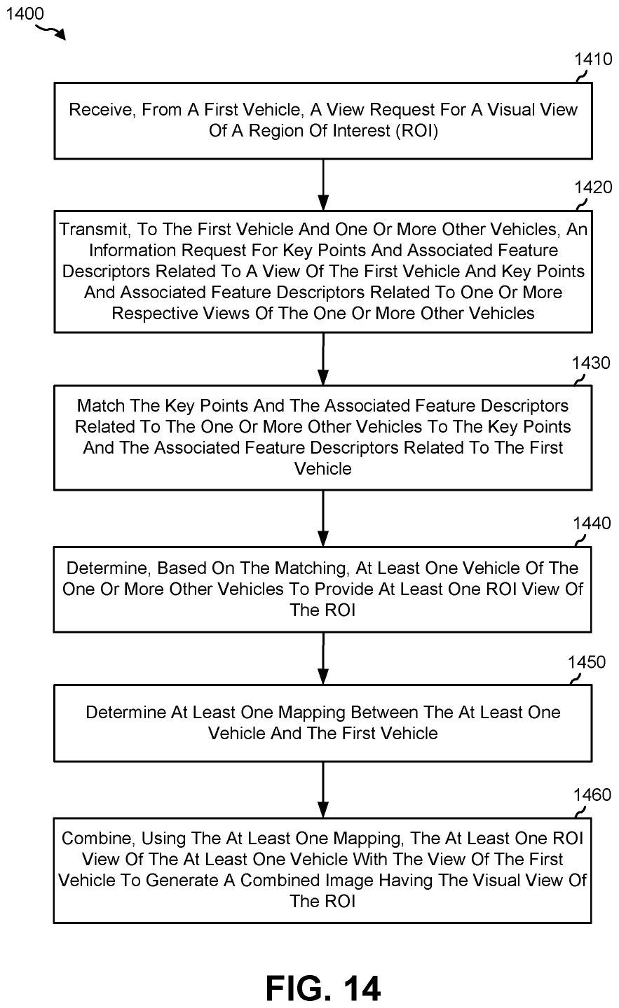

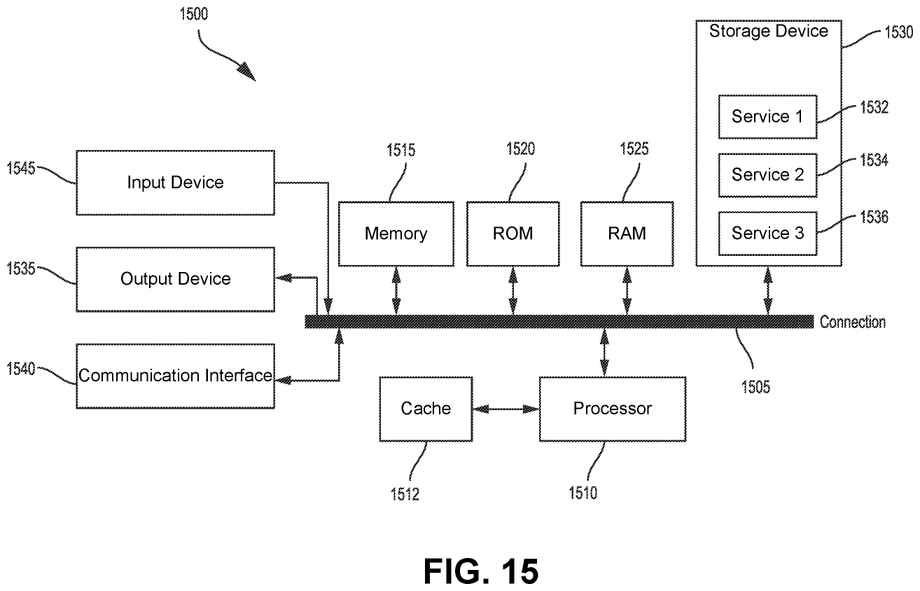

FIG. 14 is a flow chart illustrating an example of a process 1400 for a cloud-based virtual view for V2V applications. The process 1400 can be performed by a device or by a component, system, or apparatus of the device (e.g., a chipset of the device, one or more processors of the device, or other component or system of the device). The device can be a server (e.g., C2C server 940 of FIG. 9), a computing device such as a user equipment (UE) (e.g., the user device 104 of FIG. 1, the UE 221 of FIG. 2, etc.), a vehicle (e.g., the vehicle 404 of FIG. 4, the vehicle 510b of FIG. 5, etc.), a base station (e.g., the base station 102 of FIG. 1, the disaggregated base station 201 of FIG. 2, etc.), a roadside unit (RSU), or other device. The operations of the process 1400 may be implemented as software components that are executed and run on one or more processors (e.g., processor 1510 of FIG. 15 or other processor(s)) of the device. Further, the transmission and reception of signals by the device in the process 1400 may be enabled, for example, by one or more antennas and/or one or more transceivers (e.g., wireless transceiver(s)) of the device.

At block 1410, the device (or component thereof) can receive, from a first vehicle, a view request for a visual view of a region of interest (ROI). Referring to FIG. 13 as an illustrative example, the vehicle 1310 (e.g., first vehicle, which is a requesting vehicle) can send a view request to the C2C server 1360 to provide a visual view (e.g., a panoramic visual view) of the ROI 1350. The ROI can be of any shape, such as a circle, a square, a rectangle, a triangle, a polygon, or other shape. In some cases, the ROI can be explicitly indicated by the first vehicle to the device. In other cases, the ROI can be implicitly determined by the device (e.g., a C2C server) based on the current location of the first vehicle and/or other vehicles. In one illustrative example, a second vehicle (e.g., a truck) may be right in front of and blocking a view of the first vehicle (e.g., a car). Based on the position of first and second vehicle, the device can determine visual view of the ROI as requested by the first vehicle.

In some aspects, the view request includes coordinates for the ROI. Additionally or alternatively, the view request can include a raw image and/or a compressed image of the ROI. In some cases, the view request can include vehicle information of the first vehicle and/or camera information of the first vehicle. For example, the vehicle information can include a location of the first vehicle, a make of the first vehicle, and/or a model of the first vehicle. In some examples, the camera information can include a camera rotation, camera intrinsic parameters, and/or camera extrinsic parameters of a camera of the first vehicle

At block 1420, the device (or component thereof) can transmit (or output for transmission) to the first vehicle and one or more other vehicles, an information request for key points and associated feature descriptors related to a view of the first vehicle and key points and associated feature descriptors related to one or more respective views of the one or more other vehicles. Referring again to FIG. 13 as an illustrative example, once the C2C server 1360 receives the request from the vehicle 1310 (e.g., first vehicle), the C2C server 1360 can request the vehicle 1310 and other nearby vehicles (e.g., vehicles 1320, 1330, 1340) located in the vicinity of the vehicle 1310 to provide the visual key points and associated feature descriptors of their views to the C2C server 1360.

In some aspects, the information request can include a key point detection method to use for detecting the key points. Illustrative examples of the key point detection method include a Harris corner detector, a features from an accelerated segment test (FAST), a speeded up robust features (SURF), any combination thereof, and/or other type of key point detection method. Additionally or alternatively, the information request can include one or more types of the associated feature descriptors. Illustrative examples of the one or more types of the associated feature descriptors include a binary robust independent elementary features (BRIEF), an orientated fast and rotated BRIEF (ORB), a speeded up robust features (SURF), any combination thereof, and/or other type of feature descriptor. Additionally or alternatively, the information request can include a number of the key points and the associated feature descriptors. For instance, the number of the key points can be based on an intensity metric for each of the key points (e.g., specified as a sharpness of a corner in a Harris corner measure). Additionally or alternatively, the information request can include a request that the key points are uniformly sampled in an image space. Additionally or alternatively, the information request can include at least one of a raw image or a compressed image. Additionally or alternatively, the information request can include intrinsic parameters of a camera.

At block 1430, the device (or component thereof) can match the key points and the associated feature descriptors related to the one or more other vehicles to the key points and the associated feature descriptors related to the first vehicle. Referring to FIG. 13 as an example, after the C2C server 1360 all of the requested visual key points and associated feature descriptors from the vehicle 1310 and other nearby vehicles 1320, 1330, 1340, the C2C server 1360 can use the obtained visual key points and associated feature descriptors from the vehicles 1320, 1330, 1340 to match with the obtained visual key points and associated feature descriptors from vehicle 1310.

At block 1440, the device (or component thereof) can determine, based on the matching, at least one vehicle of the one or more other vehicles to provide at least one ROI view of the ROI. Referring again to FIG. 13 as an illustrative example, based on the matching, the C2C server 1360 can determine the appropriate vehicles (e.g., vehicle 1320) that can provide a visual view (e.g., a panoramic visual view) in the ROI 1350 requested by the vehicle 1310. The scene depicted in the image 1305b illustrates how the vehicle 1320 is capable of providing a view of the ROI 1350 requested by vehicle 1310.

At block 1450, the device (or component thereof) can determine at least one mapping (e.g., at least one homography) between the at least one vehicle and the first vehicle. For instance, referring to FIG. 13, the C2C server 1360 can determine or infer a mapping (e.g., homography) between the vehicle 1310 and the vehicle 1320.

At block 1460, the device (or component thereof) can combine, using the at least one mapping, the at least one ROI view of the at least one vehicle with the view of the first vehicle to generate a combined image having the visual view of the ROI. In some aspects, the device (or component thereof) can transmit (or output for transmission) the combined image to the first vehicle. Referring to FIG. 13 as an example, the C2C server 1360 can use the mapping (e.g., homography) to combine (e.g., stitch) views of vehicle 1310 and vehicle 1320 together to generate a combined image (e.g., a stitched image), such as shown in the scene depicted in the image 1305c. In some cases, views from other vehicles can also be combined or stitched with the views of vehicle 1310 and vehicle 1320. The C2C server 1360 can then provide the combined image to the vehicle 1310. The combined image is a panoramic visual view of the road as would be viewed by the vehicle 1310.

FIG. 15 is a block diagram illustrating an example of a computing system 1500, which may be employed by the disclosed system for a cloud-based virtual view for V2V applications. In particular, FIG. 15 illustrates an example of computing system 1500, which can be for example any computing device making up internal computing system, a remote computing system, a camera, or any component thereof in which the components of the system are in communication with each other using connection 1505. Connection 1505 can be a physical connection using a bus, or a direct connection into processor 1510, such as in a chipset architecture. Connection 1505 can also be a virtual connection, networked connection, or logical connection.

In some aspects, computing system 1500 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1500 includes at least one processing unit (CPU or processor) 1510 and connection 1505 that communicatively couples various system components including system memory 1515, such as read-only memory (ROM) 1520 and random access memory (RAM) 1525 to processor 1510. Computing system 1500 can include a cache 1512 of high-speed memory connected directly with, in close proximity to, or integrated as part of processor 1510.

Processor 1510 can include any general purpose processor and a hardware service or software service, such as services 1532, 1534, and 1536 stored in storage device 1530, configured to control processor 1510 as well as a special-purpose processor where software instructions are incorporated into the actual processor design. Processor 1510 may essentially be a completely self-contained computing system, containing multiple cores or processors, a bus, memory controller, cache, etc. A multi-core processor may be symmetric or asymmetric.

To enable user interaction, computing system 1500 includes an input device 1545, which can represent any number of input mechanisms, such as a microphone for speech, a touch-sensitive screen for gesture or graphical input, keyboard, mouse, motion input, speech, etc. Computing system 1500 can also include output device 1535, which can be one or more of a number of output mechanisms. In some instances, multimodal systems can enable a user to provide multiple types of input/output to communicate with computing system 1500.

Computing system 1500 can include communications interface 1540, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1540 may also include one or more range sensors (e.g., LIDAR sensors, laser range finders, RF radars, ultrasonic sensors, and infrared (IR) sensors) configured to collect data and provide measurements to processor 1510, whereby processor 1510 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1540 may also include one or more Global Navigation Satellite System (GNSS) receivers or transceivers that are used to determine a location of the computing system 1500 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1530 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1530 can include software services, servers, services, etc., that when the code that defines such software is executed by the processor 1510, it causes the system to perform a function. In some aspects, a hardware service that performs a particular function can include the software component stored in a computer-readable medium in connection with the necessary hardware components, such as processor 1510, connection 1505, output device 1535, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically crasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Claim language or other language reciting “at least one processor configured to,” “at least one processor being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X. Y, and Z such that together the multiple processors perform X, Y, and Z; or that a group of multiple processors work together to perform operations X, Y, and Z. In another example, claim language reciting “at least one processor configured to: X. Y. and Z” can mean that any single processor may only perform at least a subset of operations X, Y, and Z.

Illustrative aspects of the disclosure include:

Aspect 1. An apparatus for wireless communications, the apparatus comprising: at least one memory; and at least one processor coupled to the at least one memory and configured to: receive, from a first vehicle, a view request for a visual view of a region of interest (ROI); output, for transmission to the first vehicle and one or more other vehicles, an information request for key points and associated feature descriptors related to a view of the first vehicle and key points and associated feature descriptors related to one or more respective views of the one or more other vehicles; match the key points and the associated feature descriptors related to the one or more other vehicles to the key points and the associated feature descriptors related to the first vehicle; determine, based on the matching, at least one vehicle of the one or more other vehicles to provide at least one ROI view of the ROI; determine at least one mapping between the at least one vehicle and the first vehicle; and combine, using the at least one mapping, the at least one ROI view of the at least one vehicle with the view of the first vehicle to generate a combined image having the visual view of the ROI.

Aspect 2. The apparatus of Aspect 1, wherein the at least one processor is configured to output the combined image for transmission to the first vehicle.

Aspect 3. The apparatus of any one of Aspects 1 or 2, wherein the apparatus is a car-to-cloud (C2C) server.

Aspect 4. The apparatus of any one of Aspects 1 to 3, wherein a shape of the ROI is one of a circle, a square, a rectangle, a triangle, or a polygon.

Aspect 5. The apparatus of any one of Aspects 1 to 4, wherein the view request comprises coordinates for the ROI and at least one of a raw image or a compressed image.

Aspect 6. The apparatus of any one of Aspects 1 to 5, wherein the view request comprises at least one of vehicle information of the first vehicle or camera information of the first vehicle.

Aspect 7. The apparatus of Aspect 6, wherein the vehicle information comprises at least one of a location of the first vehicle, a make of the first vehicle, or a model of the first vehicle.

Aspect 8. The apparatus of any one of Aspects 6 or 7, wherein the camera information comprises at least one of a camera rotation, camera intrinsic parameters, or camera extrinsic parameters of a camera of the first vehicle.

Aspect 9. The apparatus of any one of Aspects 1 to 8, wherein the information request comprises at least one of a key point detection method to use for detecting the key points, one or more types of the associated feature descriptors, a number of the key points and the associated feature descriptors, a request that the key points are uniformly sampled in an image space, at least one of a raw image or a compressed image, or intrinsic parameters of a camera.

Aspect 10. The apparatus of Aspect 9, wherein the key point detection method is one of a Harris corner detector, a features from an accelerated segment test (FAST), or a speeded up robust features (SURF).

Aspect 11. The apparatus of any one of Aspects 9 or 10, wherein the one or more types of the associated feature descriptors comprises at least one of a binary robust independent elementary features (BRIEF), an orientated fast and rotated BRIEF (ORB), or a speeded up robust features (SURF).

Aspect 12. The apparatus of any one of Aspects 9 to 11, wherein the number of the key points is based on an intensity metric for each of the key points.

Aspect 13. The apparatus of Aspect 12, wherein the intensity metric for each of the key points is specified as a sharpness of a corner in a Harris corner measure.

Aspect 14. The apparatus of any one of Aspects 1 to 13, wherein the at least one mapping comprises at least one homography.

Aspect 15. A method for wireless communications by a device, the method comprising: receiving, by the device from a first vehicle, a view request for a visual view of a region of interest (ROI); transmitting, by the device to the first vehicle and one or more other vehicles, an information request for key points and associated feature descriptors related to a view of the first vehicle and key points and associated feature descriptors related to one or more respective views of the one or more other vehicles; matching, by the device, the key points and the associated feature descriptors related to the one or more other vehicles to the key points and the associated feature descriptors related to the first vehicle; determining, by the device based on the matching, at least one vehicle of the one or more other vehicles to provide at least one ROI view of the ROI; determining, by the device, at least one mapping between the at least one vehicle and the first vehicle; and combining, by the device using the at least one mapping, the at least one ROI view of the at least one vehicle with the view of the first vehicle to generate a combined image having the visual view of the ROI.

Aspect 16. The method of Aspect 15, further comprising transmitting, by the device, the combined image to the first vehicle.

Aspect 17. The method of any one of Aspects 15 or 16, wherein the device is a car-to-cloud (C2C) server.

Aspect 18. The method of any one of Aspects 15 to 17, wherein a shape of the ROI is one of a circle, a square, a rectangle, a triangle, or a polygon.

Aspect 19. The method of any one of Aspects 15 to 18, wherein the view request comprises coordinates for the ROI and at least one of a raw image or a compressed image.

Aspect 20. The method of any one of Aspects 15 to 19, wherein the view request comprises at least one of vehicle information of the first vehicle or camera information of the first vehicle.

Aspect 21. The method of Aspect 20, wherein the vehicle information comprises at least one of a location of the first vehicle, a make of the first vehicle, or a model of the first vehicle.

Aspect 22. The method of any one of Aspects 20 or 21, wherein the camera information comprises at least one of a camera rotation, camera intrinsic parameters, or camera extrinsic parameters of a camera of the first vehicle.

Aspect 23. The method of any one of Aspects 15 to 22, wherein the information request comprises at least one of a key point detection method to use for detecting the key points, one or more types of the associated feature descriptors, a number of the key points and the associated feature descriptors, a request that the key points are uniformly sampled in an image space, at least one of a raw image or a compressed image, or intrinsic parameters of a camera.

Aspect 24. The method of Aspect 23, wherein the key point detection method is one of a Harris corner detector, a features from an accelerated segment test (FAST), or a speeded up robust features (SURF).

Aspect 25. The method of any one of Aspects 23 or 24, wherein the one or more types of the associated feature descriptors comprises at least one of a binary robust independent elementary features (BRIEF), an orientated fast and rotated BRIEF (ORB), or a speeded up robust features (SURF).

Aspect 26. The method of any one of Aspects 23 to 25, wherein the number of the key points is based on an intensity metric for each of the key points.

Aspect 27. The method of Aspect 26, wherein the intensity metric for each of the key points is specified as a sharpness of a corner in a Harris corner measure.

Aspect 28. The method of any one of Aspects 15 to 27, wherein the at least one mapping comprises at least one homography.

Aspect 29. A non-transitory computer-readable storage medium comprising instructions stored thereon which, when executed by at least one processor, causes the at least one processor to perform operations according to any one of Aspects 15 to 28.

Aspect 30. An apparatus for processing image data, comprising one or more means for performing operations according to any one of Aspects 15 to 28.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. An apparatus for wireless communications, the apparatus comprising:
at least one memory; and
at least one processor coupled to the at least one memory and configured to:
receive, from a first vehicle, a view request for a visual view of a region of interest (ROI);
output, for transmission to the first vehicle and one or more other vehicles, an information request for key points and associated feature descriptors related to a view of the first vehicle and key points and associated feature descriptors related to one or more respective views of the one or more other vehicles;
match the key points and the associated feature descriptors related to the one or more other vehicles to the key points and the associated feature descriptors related to the first vehicle;
determine, based on the matching, at least one vehicle of the one or more other vehicles to provide at least one ROI view of the ROI;
determine at least one mapping between the at least one vehicle and the first vehicle; and
combine, using the at least one mapping, the at least one ROI view of the at least one vehicle with the view of the first vehicle to generate a combined image having the visual view of the ROI.

2. The apparatus of claim 1, wherein the at least one processor is configured to output the combined image for transmission to the first vehicle.

3. The apparatus of claim 1, wherein the apparatus is a car-to-cloud (C2C) server.

4. The apparatus of claim 1, wherein a shape of the ROI is one of a circle, a square, a rectangle, a triangle, or a polygon.

5. The apparatus of claim 1, wherein the view request comprises coordinates for the ROI and at least one of a raw image or a compressed image.

6. The apparatus of claim 1, wherein the view request comprises at least one of vehicle information of the first vehicle or camera information of the first vehicle.

7. The apparatus of claim 6, wherein the vehicle information comprises at least one of a location of the first vehicle, a make of the first vehicle, or a model of the first vehicle.

8. The apparatus of claim 6, wherein the camera information comprises at least one of a camera rotation, camera intrinsic parameters, or camera extrinsic parameters of a camera of the first vehicle.

9. The apparatus of claim 1, wherein the information request comprises at least one of a key point detection method to use for detecting the key points, one or more types of the associated feature descriptors, a number of the key points and the associated feature descriptors, a request that the key points are uniformly sampled in an image space, at least one of a raw image or a compressed image, or intrinsic parameters of a camera.

10. The apparatus of claim 9, wherein the key point detection method is one of a Harris corner detector, a features from an accelerated segment test (FAST), or a speeded up robust features (SURF).

11. The apparatus of claim 9, wherein the one or more types of the associated feature descriptors comprises at least one of a binary robust independent elementary features (BRIEF), an orientated fast and rotated BRIEF (ORB), or a speeded up robust features (SURF).

12. The apparatus of claim 9, wherein the number of the key points is based on an intensity metric for each of the key points.

13. The apparatus of claim 12, wherein the intensity metric for each of the key points is specified as a sharpness of a corner in a Harris corner measure.

14. The apparatus of claim 1, wherein the at least one mapping comprises at least one homography.

15. A method for wireless communications by a device, the method comprising:
receiving, by the device from a first vehicle, a view request for a visual view of a region of interest (ROI);
transmitting, by the device to the first vehicle and one or more other vehicles, an information request for key points and associated feature descriptors related to a view of the first vehicle and key points and associated feature descriptors related to one or more respective views of the one or more other vehicles;
matching, by the device, the key points and the associated feature descriptors related to the one or more other vehicles to the key points and the associated feature descriptors related to the first vehicle;
determining, by the device based on the matching, at least one vehicle of the one or more other vehicles to provide at least one ROI view of the ROI;
determining, by the device, at least one mapping between the at least one vehicle and the first vehicle; and
combining, by the device using the at least one mapping, the at least one ROI view of the at least one vehicle with the view of the first vehicle to generate a combined image having the visual view of the ROI.

16. The method of claim 15, further comprising transmitting, by the device, the combined image to the first vehicle.

17. The method of claim 15, wherein the device is a car-to-cloud (C2C) server.

18. The method of claim 15, wherein a shape of the ROI is one of a circle, a square, a rectangle, a triangle, or a polygon.

19. The method of claim 15, wherein the view request comprises coordinates for the ROI and at least one of a raw image or a compressed image.

20. The method of claim 15, wherein the view request comprises at least one of vehicle information of the first vehicle or camera information of the first vehicle.

21. The method of claim 20, wherein the vehicle information comprises at least one of a location of the first vehicle, a make of the first vehicle, or a model of the first vehicle.

22. The method of claim 20, wherein the camera information comprises at least one of a camera rotation, camera intrinsic parameters, or camera extrinsic parameters of a camera of the first vehicle.

23. The method of claim 15, wherein the information request comprises at least one of a key point detection method to use for detecting the key points, one or more types of the associated feature descriptors, a number of the key points and the associated feature descriptors, a request that the key points are uniformly sampled in an image space, at least one of a raw image or a compressed image, or intrinsic parameters of a camera.

24. The method of claim 23, wherein the key point detection method is one of a Harris corner detector, a features from an accelerated segment test (FAST), or a speeded up robust features (SURF).

25. The method of claim 23, wherein the one or more types of the associated feature descriptors comprises at least one of a binary robust independent elementary features (BRIEF), an orientated fast and rotated BRIEF (ORB), or a speeded up robust features (SURF).

26. The method of claim 23, wherein the number of the key points is based on an intensity metric for each of the key points.

27. The method of claim 26, wherein the intensity metric for each of the key points is specified as a sharpness of a corner in a Harris corner measure.

28. The method of claim 15, wherein the at least one mapping comprises at least one homography.
